(19) United States
(12) Patent Application Publication
(10) Pub. No.: US 2021/0343047 A1
(43) Pub. Date: Nov. 4, 2021

(54) THREE-DIMENSIONAL DATA POINT ENCODING AND DECODING METHOD AND DEVICE

(71) Applicant: SZ DJI TECHNOLOGY CO., LTD., Shenzhen (CN)

(72) Inventors: Pu LI, Shenzhen (CN); Fu ZHANG, Shenzhen (CN); Xiaozhen ZHENG, Shenzhen (CN)

(21) Appl. No.: 17/376,893

(22) Filed: Jul. 15, 2021

Related U.S. Application Data
(63) Continuation of application No. PCT/CN2019/071835, filed on Jan. 15, 2019.

(51) Int. Cl. G06T 9/00; G06T 9/40

(52) U.S. Cl. CPC G06T 9/001; G06T 9/40

(57) ABSTRACT

A three-dimensional data point encoding method includes determining maximum values of range values of an initial block of target three-dimensional data points in a radial distance direction, a zenith angle direction, and an azimuth angle direction according to position coordinates of the target three-dimensional data points in a spherical coordinate system, performing partitioning processes on the initial block, and encoding the target three-dimensional data points according to partitioning results of the initial block. Performing the partitioning processes on the initial block includes performing at least one octree partitioning process on the initial block to obtain a plurality of first-type sub-blocks and performing at least one of a quadtree partitioning process or a binary tree partitioning process on at least one of the plurality of first-type sub-blocks.

### CROSS-REFERENCE TO RELATED APPLICATION

This application is a continuation of International Application No. PCT/CN2019/071835, filed Jan. 15, 2019, the entire content of which is incorporated herein by reference.

### TECHNICAL FIELD

The present disclosure relates to the field of image processing technologies and, more particularly, to a three-dimensional data point encoding and decoding method and devices.

### BACKGROUND

A point cloud is a form of expression of a three-dimensional object or scene. The point cloud is composed of a set of discrete three-dimensional data points that are randomly distributed in space and express spatial structure and surface properties of the three-dimensional object or scene. To accurately reflect information in the space, the number of the discrete three-dimensional data points required is huge. To reduce the storage space occupied by the three-dimensional data points and bandwidth occupied during transmission, the three-dimensional data points need to be encoded and compressed.

In existing technologies, position coordinates of each three-dimensional data point are quantized according to difference between the maximum and minimum values of the position coordinates of the three-dimensional data points on the three axes, and the quantization accuracy determined according to the input parameters. Correspondingly, the input position coordinates of the three-dimensional data points are converted into integer coordinates greater than or equal to zero. The maximum value of the maximum values of the position coordinates in the three directions is selected, and a range value of a cube when octree partitioning is initialized is determined according to the selected maximum value. The range value is an integer power of 2 and is greater than or equal to the selected maximum value and also closest to the selected maximum value. After initializing the range value of the cube in the octree partitioning process, octree partitioning coding is performed. The partitioning of each layer of the octree uses the position coordinates of the center point of the current block for sub-block partitioning, and the current block is divided into eight small sub-blocks through the center point. After the sub-block partitioning is performed, it is determined whether there are three-dimensional data points in each sub-block, and the sub-blocks with three-dimensional data points will be further divided until the sub-blocks are divided to a minimum, that is, the range value of the sub-blocks is 1. The three-dimensional data points are encoded according to the partitioning result of the cube.

The encoding efficiency of the existing encoding methods is not good.

### SUMMARY

In accordance with the disclosure, there is provided a three-dimensional data point encoding method including determining maximum values of range values of an initial block of target three-dimensional data points in a radial distance direction, a zenith angle direction, and an azimuth angle direction according to position coordinates of the target three-dimensional data points in a spherical coordinate system, performing partitioning processes on the initial block, and encoding the target three-dimensional data points according to partitioning results of the initial block. Performing the partitioning processes on the initial block includes performing at least one octree partitioning process on the initial block to obtain a plurality of first-type sub-blocks and performing at least one of a quadtree partitioning process or a binary tree partitioning process on at least one of the plurality of first-type sub-blocks.

In accordance with the disclosure, there is also provided a three-dimensional data point decoding method including obtaining a code stream, determining, according to the code stream, maximum values of range values of an initial block in three directions including a radial distance direction, a zenith angle direction, and an azimuth angle direction, constructing the initial block according to the maximum values of the range values, performing partitioning processes on the initial block, and obtaining position coordinates of target three-dimensional data points according to positions of sub-blocks obtained by the partitioning processes. Performing the partitioning processes on the initial block includes performing at least one octree partitioning process on the initial block to obtain a plurality of first-type sub-blocks and performing at least one of a quadtree partitioning process or a binary tree partitioning process on at least one of the plurality of first-type sub-blocks.

### BRIEF DESCRIPTION OF THE DRAWINGS

The above and/or additional aspects and advantages of this disclosure will become obvious and easy to understand from the description of the embodiments in conjunction with the following drawings.

FIG. 1 is a schematic diagram of a spherical coordinate system consistent with various embodiments of the present disclosure.

FIG. 2A is a schematic flow chart of an exemplary three-dimensional data point encoding method consistent with various embodiments of the present disclosure.

FIG. 2B is a schematic diagram showing a sector block consistent with various embodiments of the present disclosure.

FIG. 2C is a schematic diagram showing a sector-ring block consistent with various embodiments of the present disclosure.

FIG. 3 is a schematic flow chart of another exemplary three-dimensional data point encoding method consistent with various embodiments of the present disclosure.

FIG. 4 is a schematic flow chart of another exemplary three-dimensional data point encoding method consistent with various embodiments of the present disclosure.

FIG. 5 is a schematic flow chart of another exemplary three-dimensional data point encoding method consistent with various embodiments of the present disclosure.

FIG. 6 is a schematic flow chart of another exemplary three-dimensional data point encoding method consistent with various embodiments of the present disclosure.

FIG. 7 is a schematic flow chart of another exemplary three-dimensional data point decoding method embodiments of the present disclosure.

FIG. 8 shows an exemplary octree partitioning process consistent with various embodiments of the present disclosure.

FIG. 9 shows an exemplary partitioning process consistent with various embodiments of the present disclosure.

FIG. 10 shows an exemplary encoding apparatus of a three-dimensional data point consistent with various embodiments of the present disclosure.

FIG. 11 shows an exemplary decoding apparatus of three-dimensional data point consistent with various embodiments of the present disclosure.

FIG. 12 shows an exemplary ranging apparatus consistent with various embodiments of the present disclosure.

FIG. 13 shows a schematic diagram of an exemplary ranging apparatus adopting a coaxial optical path consistent with various embodiments of the present disclosure.

FIG. 14 shows a scanning pattern of a ranging apparatus consistent with various embodiments of the present disclosure.

### DETAILED DESCRIPTION OF THE EMBODIMENTS

Technical solutions of the present disclosure will be described with reference to the drawings. It will be appreciated that the described embodiments are part rather than all of the embodiments of the present disclosure. Other embodiments conceived by those having ordinary skills in the art on the basis of the described embodiments without inventive efforts should fall within the scope of the present disclosure.

It should be noted that when a component is referred to as being “fixed to” another component, it can be directly on the other component or a component between them may also exist. When a component is considered to be “connected” to another component, it can be directly connected to the other component or a component between them may also exist.

Unless otherwise defined, all technical and scientific terms used herein have the same meaning as commonly understood by those skilled in the technical field of the present disclosure. The terms used in the description of the present disclosure herein are only for the purpose of describing specific embodiments, and are not intended to limit the present disclosure. The term “and/or” as used herein includes any and all combinations of one or more related listed items.

In the following, some embodiments of the present disclosure will be described in detail with reference to the accompanying drawings. In the case of no conflict, the following embodiments and features in the embodiments can be combined with each other.

The embodiments of the present disclosure are mainly aimed at a scene when value ranges of position coordinates of some three-dimensional data points in a point cloud are different in three directions.

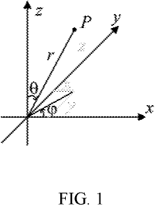

In the present disclosure, the position coordinates of the three-dimensional data points of the point cloud in a spherical coordinate system may be encoded or decoded. FIG. 1 is a schematic of the spherical coordinate system provided by one embodiment of the present disclosure. In the spherical coordinate system, a radial distance, a zenith angle and an azimuth angle are used to describe the position coordinates of the three-dimensional data points of the point cloud. Assuming that the position coordinates of a point P in the spherical coordinate system are (r, θ, φ), the radial distance r≥0 represents a linear distance from the origin to the point P, and the zenith angle 0≤θ≤π represents an angle between a line from the origin to the point P and the positive semi-axis of the z-axis. The azimuth angle 0≤φ≤2π represents an angle between the projection line of the line from the origin to the point P on the xoy plane and the positive semi-axis of the x-axis.

In the embodiments of the present disclosure, a minimum accuracy in each direction is a range value in each direction of the sub-block obtained at the end of the partitioning. The minimum accuracy of each direction can be preset before encoding. The minimum accuracy of each direction can be the same or different.

In each embodiment of the present disclosure, for ease of description, sub-blocks obtained by performing octree partitioning at any time are called first-type sub-blocks, and sub-blocks obtained by performing quadtree partitioning at any one time are called second-type sub-blocks. Sub-blocks obtained by performing the binary tree partitioning at any one time are called third-type sub-blocks.

In the present disclosure, the three directions of the three-dimensional data points are the radial distance direction, the zenith angle direction, and the azimuth angle direction. The three directions of the initial block described also are the radial distance direction, the zenith angle direction, and the azimuth angle direction.

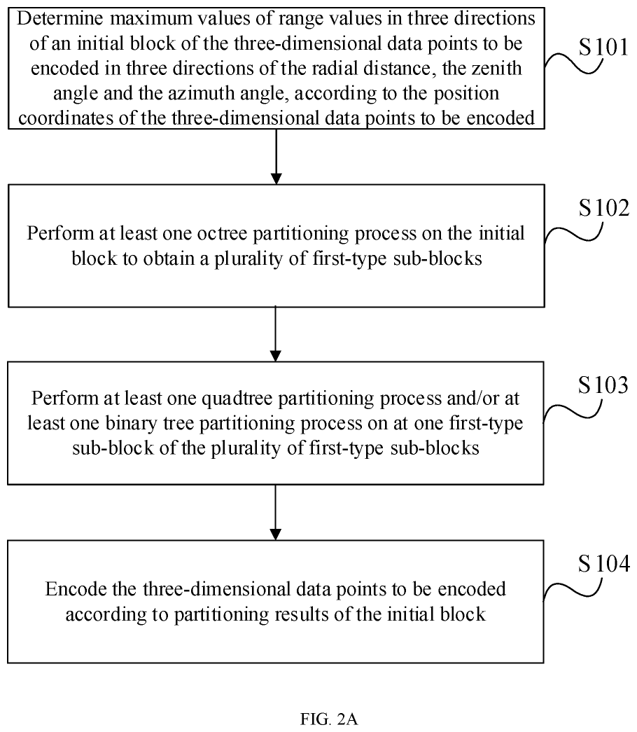

The present disclosure provides a three-dimensional data point encoding method. As shown in FIG. 2A, in one embodiment, the method includes S101 to S104.

In S101, according to position coordinates of three-dimensional data points to be encoded (also referred to as “to-be-encoded three-dimensional data points” or “target three-dimensional data points”) in the spherical coordinate system, maximum values of range values along the radial distance direction, the zenith angle direction, and the azimuth angle direction of initial block of the three-dimensional data points to be encoded are determined.

In one embodiment, the position coordinates of the three-dimensional data points to be encoded may be quantized, and maximum values and minimum values of the position coordinates of the three-dimensional data points in the three directions may be obtained according to the quantized position coordinates of the three-dimensional data points. According to the maximum values and minimum values of the position coordinates of the three-dimensional data points in the three directions, the maximum values of the range values of the position coordinates of the three-dimensional data points in the three directions may be determined. And then according to the maximum values of the range values of the position coordinates of the three-dimensional data points in the three directions, the maximum values of the range values of initial block of the three-dimensional data points to be encoded in the three directions may be determined.

Optionally, in each direction, the value among the values that are the integer power of 2 and are greater than or equal to the maximum value of the range value of the position coordinates of the three-dimensional data point that is closest to the maximum value of the range value may be obtained as the maximum value of the range value of initial block in the corresponding direction.

In one embodiment, the position coordinates of the three-dimensional data points to be encoded may be quantized by at least one of:

quantizing the radial distance of the position coordinates of the three-dimensional data points according to a quantization step length in the radial distance direction;

quantizing the zenith angle of the position coordinates of the three-dimensional data points according to a quantization step length in the zenith angle direction; or

quantizing the azimuth angle of the position coordinates of the three-dimensional data points according to a quantization step length in the azimuth angle direction.

Optionally, the radial distance of the position coordinates of the three-dimensional data points may be quantized according to

$${\hat{r}}_{i} = Round ( \frac{{r}_{i}}{{r}_{Δ}} ) ,$$

and/or, the zenith angle of the position coordinates of the three-dimensional data points may be quantized according to

$${\hat{θ}}_{i} = Round ( \frac{{θ}_{i}}{{θ}_{Δ}} ) ,$$

and/or the azimuth angle of the position coordinates of the three-dimensional data points may be quantized according to

$${\hat{φ}}_{i} = Round ( \frac{{φ}_{i}}{{φ}_{Δ}} ) ,$$

wherein rᵢ is a value of a radial distance of the i-th three-dimensional data point of of the three-dimensional data points before quantization, r_{Δ} is the quantization step length in the radial distance direction, \hat{r}ᵢ is a value of the radial distance of the i-th three-dimensional data point of of the three-dimensional data points after quantization, θᵢ is a value of a zenith angle of the i-th three-dimensional data point of of the three-dimensional data points before quantization, θ_{Δ} is the quantization step length in the zenith angle direction, \hat{θ}ᵢ is a value of the zenith angle of the i-th three-dimensional data point of of the three-dimensional data points after quantization, φᵢ is a value of an azimuth angle of the i-th three-dimensional data point of of the three-dimensional data points before quantization, φ_{Δ} is the quantization step length in the azimuth angle direction, \hat{φ}ᵢ is a value of the azimuth angle of the i-th three-dimensional data point of of the three-dimensional data points after quantization, Round(x) is a Round function returning a value which is a result of rounding operation according to the specified number of decimal places.

In some embodiments, the initial block may be a sector block shown in FIG. 2B or a sector ring block shown in FIG. 2C.

In another embodiment, the position coordinates of the three-dimensional data points to be encoded may be quantized by at least one of:

quantizing the radial distance of the position coordinates of the three-dimensional data points according to a quantization step length in the radial distance direction and a minimum value in the radial distance direction;

quantizing the zenith angle of the position coordinates of the three-dimensional data points according to a quantization step length in the zenith angle direction and a minimum value in the zenith angle direction; or

quantizing the azimuth angle of the position coordinates of the three-dimensional data points according to a quantization step length in the azimuth angle direction and a minimum value in the azimuth angle direction.

Optionally, the radial distance of the position coordinates of the three-dimensional data points may be quantized according to

$${\hat{r}}_{i} = Round ( \frac{( {r}_{i} - {r}_{min} )}{{r}_{Δ}} ) ,$$

and/or, the zenith angle of the position coordinates of the three-dimensional data points may be quantized according to

$${\hat{θ}}_{i} = Round ( \frac{{θ}_{i} - {θ}_{min}}{{θ}_{Δ}} ) ,$$

and/or the azimuth angle of the position coordinates of the three-dimensional data points may be quantized according to

$${\hat{φ}}_{i} = Round ( \frac{{φ}_{i} - {φ}_{min}}{{φ}_{Δ}} ) ,$$

wherein rᵢ is a value of a radial distance of the i-th three-dimensional data points of the three-dimensional data points before quantization, rₘᵢₙ is the minimum value of the three-dimensional data points in the radial distance direction before quantization, r_{Δ} is the quantization step length in the radial distance direction, \hat{r}ᵢ is a value of the radial distance of the i-th three-dimensional data point of of the three-dimensional data points after quantization, θᵢ is a value of a zenith angle of the i-th three-dimensional data point of of the three-dimensional data points before quantization, θₘᵢₙ is the minimum value of the three-dimensional data points in the zenith angle direction before quantization, θ_{Δ} is the quantization step length in the zenith angle direction, \hat{θ}ᵢ is a value of the zenith angle of the i-th three-dimensional data point of of the three-dimensional data points after quantization, φᵢ is a value of an azimuth angle of the i-th three-dimensional data point of of the three-dimensional data points before quantization, φₘᵢₙ is the minimum value of the three-dimensional data points in the azimuth angle direction before quantization, φ_{Δ} is the quantization step length in the azimuth angle direction, \hat{φ}ᵢ is a value of the azimuth angle of the i-th three-dimensional data point of of the three-dimensional data points after quantization, Round(x) is a Round function returning a value which is a result of rounding operation according to the specified number of decimal places.

In some embodiments, the minimum value in each direction may be 0, and the initial block may be a sector block shown in FIG. 2B.

Optionally, the initial block can cover all three-dimensional data points or part of the three-dimensional data points of the point cloud.

Optionally, the initial block is a part of the sphere, for example, may be sector blocks or sector ring blocks.

Optionally, the center of the sphere may be the position of the three-dimensional data point acquisition device. Among them, the three-dimensional data point acquisition device may be a laser radar, an optoelectronic radar, or a laser scanner.

In S102, at least one octree partitioning process is performed on the initial block, to obtain a plurality of first-type sub-blocks.

The at least one octree partitioning process is performed on the initial block and eight sub-blocks are obtained after each octree partitioning process of the at least one octree partitioning process. Each partitioning process is to divide the sub-blocks containing the position coordinates of the three-dimensional data points obtained by the previous partitioning until the range values of the sub-blocks obtained by one or two directions reach the minimum accuracy.

Optionally, one octree partitioning process of the at least one octree partitioning process may be performed according to the coordinates of center points of the plurality of first-type sub-blocks obtained by the previous partitioning process.

In one embodiment, one octree partitioning process may include:

assuming that the coordinates of the center point of one of the previous first-type sub-blocks are (r_{mid}, θ_{mid}, φ_{mid}), the coordinate ranges corresponding to the eight sub-blocks obtained by the current octree partitioning process may be respectively: the coordinate range of the first sub-block is r≤r_{mid}, θ≤θ_{mid}, φ≤φ_{mid}, the coordinate value range of the second sub-block is r≤r_{mid}, θ≤θ_{mid}, φ>φ_{mid}, and the coordinate value range of the third sub-block is r≤r_{mid}, θ>θ_{mid}, φ≤φ_{mid}, the coordinate value range of the fourth sub-block is r≤r_{mid}, θ>θ_{mid}, φ>φ_{mid}, the coordinate value range of the fifth sub-block is r>r_{mid}, θ≤θ_{mid}, φ≤φ_{mid}, the coordinate value range of the sixth sub-block is r>r_{mid}, θ≤θ_{mid}, φ>φ_{mid}, the coordinate value range of the seventh sub-block is r>r_{mid}, θ>θ_{mid}, φ≤φ_{mid}, and the coordinate value range of the eighth sub-block is r>r_{mid}, θ>θ_{mid}, φ>φ_{mid}.

The coordinates of the center points in the radial distance direction may be obtained according to

$${r}_{mid} = \frac{{r}_{min} + {r}_{max}}{2} ,$$

and/or, me coordinates of the center points in the zenith angle direction may be obtained according to

$${θ}_{mid} = \frac{{θ}_{min} + {θ}_{max}}{2} ,$$

and/or the coordinates of the center points in the azimuth angle direction may be obtained according to

$${φ}_{mid} = \frac{{φ}_{min} + {φ}_{max}}{2} .$$

(r_{mid}, θ_{mid}, φ_{mid}) is the coordinates of the center points. rₘᵢₙ is the minimum value of the blocks to be partitioned in the radial direction, rₘₐₓ is the maximum value of the blocks to be partitioned in the radial direction, θₘᵢₙ is the minimum value of the blocks to be partitioned in the zenith angle direction, θₘₐₓ is the maximum value of the blocks to be partitioned in the zenith angle direction, φₘᵢₙ is the minimum value of the blocks to be partitioned in the azimuth angle direction, φₘₐₓ is the maximum value of the blocks to be partitioned in the azimuth angle direction.

In S103, at least one quad-tree partitioning process and/or at least one binary tree partitioning is performed on at least one first-type sub-block of the plurality of first-type sub-blocks.

The range values in the three directions of the initial block is different, and the partitioning methods are different correspondingly. It may include but be not limited to following possible cases.

In one possible case, the range values of the three directions of the initial block may be all different. Therefore, after the octree partitioning is completed, quadtree partitioning and binary tree partitioning may be required.

In another possible case, the range values of two directions of the initial block may be equal, and the same range values are greater than the range value of the other direction. Then after the octree partitioning is completed, only the quadtree partitioning may be required.

In another possible case, the range values of two directions of the initial block is equal, and the same range value is less than the range value of the other direction. Then after the octree partitioning is completed, only the binary tree partitioning may be required before the end.

In S104, the three-dimensional data points to be encoded are encoded according to the partitioning results of the initial block.

In some embodiments, according to the position coordinates of the three-dimensional data points to be encoded, the maximum values of the range values of the initial block of the three-dimensional data points to be encoded in the radial distance direction, the zenith angle direction, and the azimuth angle direction may be determined, and then the initial block may be partitioned by using the at least one octree partitioning process to obtain the plurality of first-type sub-blocks. The at least one quad-tree partitioning process and/or binary-tree partitioning process may be performed on at least one first-type sub-block of the plurality of first-type sub-blocks, and the three-dimensional data points to be encoded may be encoded according to the result of the partitioning of the initial block. Since the range values in the three directions of the initial block constructed to divide the distribution of three-dimensional data points in the space may be different, the number of the partitioning processes necessary for the range values in the three directions to reach the minimum accuracy may be different during the partitioning. When one range value reaches the minimum accuracy, the quad-tree partitioning or the binary tree partitioning may be used for partitioning until the range values in the three directions all reach the minimum accuracy. The number of the partitioning processes may be reduced and the encoding and decoding efficiency may be improved.

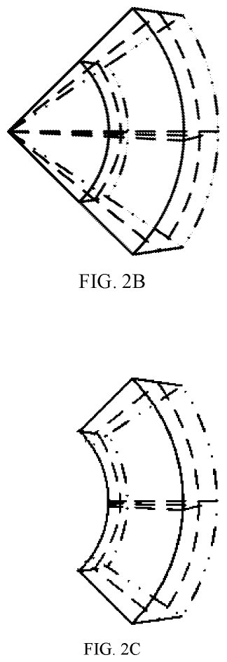

FIG. 3 is a schematic flow chart of another exemplary three-dimensional data point encoding method. Based on the embodiment in FIG. 2A, FIG. 3 shows a possible implementation of S103 when the range values in the three directions of the initial block are all different. As shown in FIG. 3, the example implementation of S103 includes S1031a to S1032a.

In S1031a, at least one quadtree partitioning process is performed on at least one first-type sub-block of the plurality of first-type sub-blocks to obtain a plurality of second-type sub-blocks, until the range values of the plurality of second-type sub-blocks in two directions reach minimum accuracy.

In one embodiment, first-type target sub-bocks of the plurality of first-type sub-blocks may be determined. Optionally, the first-type target sub-blocks may be sub-blocks of the plurality of first-type sub-blocks whose range values in one direction reach the minimum accuracy and contains three-dimensional data points. At least one quadtree partitioning process may be performed on the first-type target sub-blocks.

Specifically, at least one quadtree partitioning process may be performed on the first-type target sub-blocks and four second-type sub-blocks may be obtained after each quadtree partitioning process of the at least one quadtree partitioning process. Each quadtree partitioning process of the at least one quadtree partitioning process may be partitioning on the second sub-blocks containing the position coordinates of the three-dimensional data points obtained by a previous partitioning process, until the range values of the plurality of second-type sub-blocks in two directions reach minimum accuracy.

Optionally, the quadtree partitioning may be performed according to the coordinates of the center points of the first-type target sub-blocks obtained by the previous partitioning process.

In one implantation of the quadtree partitioning process:

when the range value in the radial direction reaches the minimum accuracy, the coordinates of the center points of the first-type target sub-blocks are (θ_{mid}, φ_{mid}), the coordinate range of the first second-type sub-block is θ≤θ_{mid}, φ≤φ_{mid}, the coordinate value range of the second second-type sub-block is θ≤θ_{mid}, φ>φ_{mid}, and the coordinate value range of the third second-type sub-block is θ>θ_{mid}, φ≤φ_{mid}, the coordinate value range of the fourth second-type sub-block is θ>θ_{mid}, φ>φ_{mid};

when the range value in the zenith angle direction reaches the minimum accuracy, the coordinates of the center points of the first-type target sub-blocks are (r_{mid}, φ_{mid}), the coordinate range of the first second-type sub-block is r≤r_{mid}, φ≤φ_{mid}, the coordinate value range of the second second-type sub-block is r≤r_{mid}, φ>φ_{mid}, and the coordinate value range of the third second-type sub-blocks is r>r_{mid}, φ≤φ_{mid}, the coordinate value range of the fourth second-type sub-block is r>r_{mid}, φ>φ_{mid}.

when the range value in the azimuth angle direction reaches the minimum accuracy, the coordinates of the center points of the first-type target sub-blocks are (r_{mid}, θ_{mid}), the coordinate range of the first second-type sub-block is r≤r_{mid}, θ≤θ_{mid}, the coordinate value range of the second second-type sub-block is r≤r_{mid}, θ>θ_{mid}, the coordinate value range of the third second-type sub-block is r>r_{mid}, θ≤θ_{mid}, the coordinate value range of the fourth second-type sub-block is r>r_{mid}, θ>θ_{mid}.

In S1032a, at least one binary tree partitioning process is performed on at least one second-type sub-block of the second-type sub-blocks to obtain third-type sub-blocks, until the range values in the three directions of the third-type sub-blocks reach the minimum accuracy.

In one embodiment, a second-type target sub-bock of the second-type sub-blocks may be determined. Optionally, the second-type target sub-block may be one sub-block of the second-type sub-blocks whose range values in two directions reach the minimum accuracy and contains three-dimensional data points. At least one binary tree partitioning process may be performed on the second-type target sub-block.

Specifically, at least one binary tree partitioning process may be performed on the second-type target sub-block and second third-type sub-blocks may be obtained after each binary tree partitioning process of the at least one binary tree partitioning process. Each binary tree partitioning process of the at least one binary tree partitioning process may be partitioning on the sub-blocks containing the position coordinates of the three-dimensional data points obtained by a previous partitioning process, until the range values in the three directions of the third-type sub-blocks reach the minimum accuracy.

In one implantation of one binary tree partitioning process:

when the range values in the radial distance direction and the zenith angle direction reach the minimum accuracy, the coordinates of the center points of the third-type sub-blocks are (φ_{mid}), the coordinate range of the first third-type sub-block is φ≤φ_{mid}, the coordinate value range of the second third-type sub-block is φ22 φ_{mid};

when the range values in the radial distance direction and the azimuth angle direction reach the minimum accuracy, the coordinates of the center points of the third-type sub-blocks are (θ_{mid}), the coordinate range of the first third-type sub-block is θ≤θ_{mid}, the coordinate value range of the second third-type sub-block is θ>θ_{mid};

when the range values in the zenith angle direction and the azimuth angle direction reach the minimum accuracy, the coordinates of the center points of the third-type sub-blocks are (r_{mid}), the coordinate range of the first third-type sub-block is r≤r_{mid}, the coordinate value range of the second third-type sub-block is r>r_{mid}.

In some embodiments, the maximum value of the range values in three directions of the initial block of the three-dimensional data points to be encoded may be obtained according to the position coordinates of the three-dimensional data points to be encoded, and then at least one octree partitioning may be performed on the initial block to obtain the plurality of first-type sub-blocks. At least one quadtree partitioning process may be performed on at least one first-type sub-block of the plurality of first-type sub-blocks, to obtain the second-type sub-blocks, until the range values in the two directions of the second-type sub-blocks reach the minimum accuracy. At least one binary tree partitioning process may be performed on at least one second-type sub-block to obtain the third-type sub-blocks until the range values in the three directions of the third-type sub-blocks reach the minimum accuracy. Subsequently, the three-dimensional data points to be encoded may be encoded according to the partitioning results of the initial block. That is, when the range values of the initial block in three directions are all different, a partitioning process mixing the octree, quadtree, and binary tree may be used to partition the initial block that is constructed to partition the distribution of the three-dimensional data points. The number of partitionings (i.e., the number of the times that partitioning is performed) may be reduced and encoding and decoding efficiency may be improved. The reduction in the number of partitionings may reduce lengths of encoding streams accordingly, and the position coordinates of the three-dimensional data points may be more effectively compressed. When encoding, different bit lengths can also be used for encoding with respect to different partitioning methods. The lengths of the code streams can be further reduced, and the encoding efficiency and compression efficiency can be further improved.

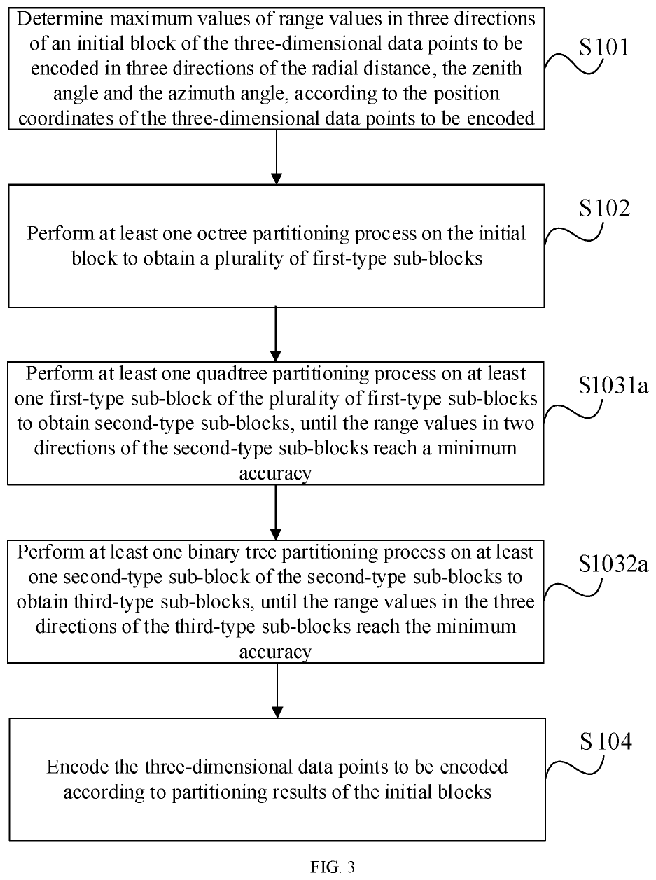

FIG. 4 is a schematic flow chart of another exemplary three-dimensional data point encoding method. Based on the embodiment in FIG. 2A, FIG. 4 shows a possible implementation of S103 when the range values in two directions of the initial block are same and larger than a range value in another direction. As shown in FIG. 4, the example implementation of S103 includes S103b.

In S 103b, at least one quadtree partitioning process is performed on at least one first-type sub-block of the plurality of first-type sub-blocks to obtain a plurality of second-type sub-blocks, until the range values in the three directions of the plurality of second-type sub-blocks reach the minimum accuracy.

In one embodiment, first-type target sub-bocks of the plurality of first-type sub-blocks may be determined. Optionally, the first-type target sub-blocks may be sub-blocks of the plurality of first-type sub-blocks whose range values in one direction reach the minimum accuracy and contains three-dimensional data points. At least one quadtree partitioning process may be performed on the first-type target sub-blocks.

Specifically, at least one quadtree partitioning process may be performed on the first-type target sub-blocks and four second-type sub-blocks may be obtained after each quadtree partitioning process of the at least one quadtree partitioning process. Each quadtree partitioning process of the at least one quadtree partitioning process may be partitioning on the plurality of second sub-blocks containing the position coordinates of the three-dimensional data points obtained by a previous partitioning process, until the range values in both directions of the second-type sub-blocks obtained by the partitioning reach the minimum accuracy.

Optionally, the octree partitioning may be performed according to the coordinates of the center points of the first-type target sub-blocks obtained by the previous partitioning process.

In one implantation of one quadtree partitioning process:

when the range value in the radial direction reaches the minimum accuracy, the coordinates of the center points of the first-type target sub-blocks are (θ_{mid}, φ_{mid}), the coordinate range of the first second-type sub-block is θ≤θ_{mid}, φ≤φ_{mid}, the coordinate value range of the second second-type sub-block is θ≤θ_{mid}, φ>φ_{mid}, and the coordinate value range of the third second-type sub-block is θ>θ_{mid}, φ≤φ_{mid}, the coordinate value range of the fourth second-type sub-block is θ>θ_{mid}, φ>φ_{mid};

when the range value in the zenith angle direction reaches the minimum accuracy, the coordinates of the center points of the first-type target sub-blocks are (r_{mid}, φ_{mid}), the coordinate range of the first second-type sub-block is r≤r_{mid}, φ≤φ_{mid}, the coordinate value range of the second second-type sub-block is r≤r_{mid}, φ>φ_{mid}, and the coordinate value range of the third second-type sub-blocks is r>r_{mid}, φ≤φ_{mid}, the coordinate value range of the fourth second-type sub-block is r>r_{mid}, φ>φ_{mid}.

when the range value in the azimuth angle direction reaches the minimum accuracy, the coordinates of the center points of the first-type target sub-blocks are (r_{mid}, θ_{mid}), the coordinate range of the first second-type sub-block is r≤r_{mid}, θ≤θ_{mid}, the coordinate value range of the second second-type sub-block is r≤r_{mid}, θ>θ_{mid}, the coordinate value range of the third second-type sub-block is r>r_{mid}, θ≤θ_{mid}, the coordinate value range of the fourth second-type sub-block is r>r_{mid}, θ>θ_{mid}.

In some embodiments, the maximum value of the range values in three directions of the initial block of the three-dimensional data points to be encoded may be obtained according to the position coordinates of the three-dimensional data points to be encoded, and then at least one octree partitioning may be performed on the initial block to obtain the plurality of first-type sub-blocks. At least one quadtree partitioning process may be performed on at least one first-type sub-block of the plurality of first-type sub-blocks, to obtain the second-type sub-blocks, until the range values in the three directions of the second-type sub-blocks reach the minimum accuracy. Subsequently, the three-dimensional data points to be encoded may be encoded according to the partitioning results of the initial block. That is, when the range values of the initial block in two of the three directions are same and larger than the range value in a remaining direction of the three directions, a partitioning process mixing the octree and binary tree may be used to partition the initial block that is constructed to partition the distribution of the three-dimensional data points. The number of partitionings may be reduced and encoding and decoding efficiency may be improved. The reduction in the number of partitionings may reduce lengths of encoding streams accordingly, and the position coordinates of the three-dimensional data points may be more effectively compressed. When encoding, different bit lengths can also be used for encoding with respect to different partitioning methods. The lengths of the code streams can be further reduced, and the encoding efficiency and compression efficiency can be further improved.

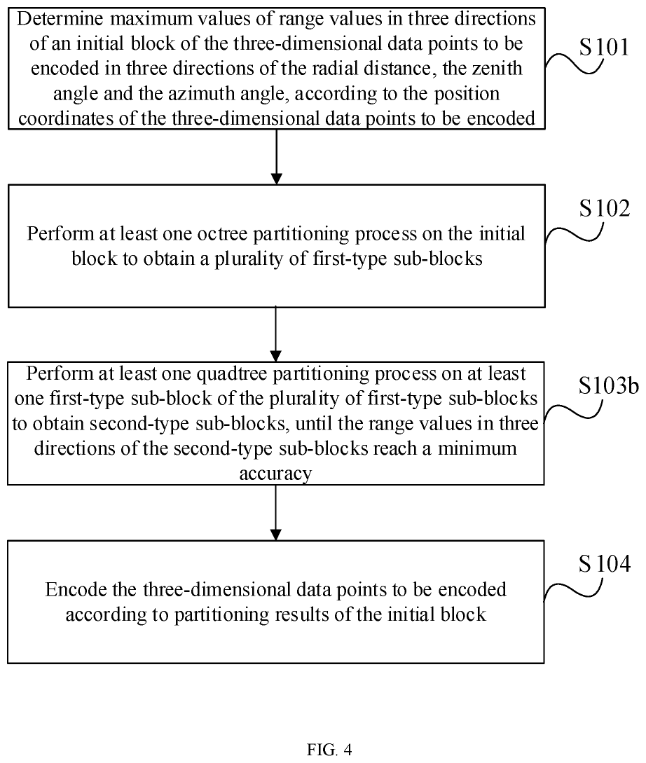

FIG. 5 is a schematic flow chart of another exemplary three-dimensional data point encoding method. Based on the embodiment in FIG. 2A, FIG. 5 shows a possible implementation of S103 when the range values in two directions of the initial block are same and smaller than a range value in another direction. As shown in FIG. 5, the example implementation of S103 includes S103c.

In S103c, at least one binary tree partitioning process is performed on at least one first-type sub-block of the plurality of first-type sub-blocks to obtain a plurality of third-type sub-blocks, until the range values in the three directions of the plurality of third-type sub-blocks reach the minimum accuracy.

In one embodiment, first-type target sub-bocks of the plurality of first-type sub-blocks may be determined. Optionally, the first-type target sub-blocks may be sub-blocks of the plurality of first-type sub-blocks whose range values in two directions of the three directions reach the minimum accuracy and contains three-dimensional data points. At least one binary tree partitioning process may be performed on the first-type target sub-blocks.

Specifically, at least one binary tree partitioning process may be performed on the first-type target sub-blocks and two sub-blocks may be obtained after each binary tree partitioning process of the at least one binary tree partitioning process. Each binary tree partitioning process of the at least one binary tree partitioning process may be partitioning on the plurality of third-type sub-blocks containing the position coordinates of the three-dimensional data points obtained by a previous partitioning process, until the range values in the three directions of the plurality of third-type sub-blocks obtained by the partitioning reach the minimum accuracy.

In one implantation of one binary tree partitioning process: when the range values in the radial distance direction and the zenith angle direction reach the minimum accuracy, the coordinates of the center points of the third-type sub-blocks are (φ_{mid}), the coordinate range of the first third-type sub-block is φ≤φ_{mid}, the coordinate value range of the second third-type sub-block is φ>φ_{mid};

when the range values in the radial distance direction and the azimuth angle direction reach the minimum accuracy, the coordinates of the center points of the third-type sub-blocks are (θ_{mid}), the coordinate range of the first third-type sub-block is θ≤θ_{mid}, the coordinate value range of the second third-type sub-block is θ>θ_{mid};

when the range values in the zenith angle direction and the azimuth angle direction reach the minimum accuracy, the coordinates of the center points of the third-type sub-blocks are (r_{mid}), the coordinate range of the first third-type sub-block is r≤r_{mid}, the coordinate value range of the second third-type sub-block is r>r_{mid}.

In some embodiments, the maximum value of the range values in the three directions of the initial block of the three-dimensional data points to be encoded may be obtained according to the position coordinates of the three-dimensional data points to be encoded, and then at least one octree partitioning may be performed on the initial block to obtain the plurality of first-type sub-blocks. At least one binary partitioning process may be performed on at least one first-type sub-block of the plurality of first-type sub-blocks, to obtain the plurality of third-type sub-blocks, until the range values in the three directions of the plurality of third-type sub-blocks reach the minimum accuracy. Subsequently, the three-dimensional data points to be encoded may be encoded according to the partitioning results of the initial block. That is, when the range values in two directions of the initial block are same and smaller than a range value in another direction, a partitioning process mixing the octree and binary tree may be used to partition the initial block that is constructed to partition the distribution of the three-dimensional data points. The number of partitionings may be reduced and encoding and decoding efficiency may be improved. The reduction in the number of partitionings may reduce lengths of encoding streams accordingly, and the position coordinates of the three-dimensional data points may be more effectively compressed. When encoding, different bit lengths can also be used for encoding with respect to different partitioning methods. The lengths of the code streams can be further reduced, and the encoding efficiency and compression efficiency can be further improved.

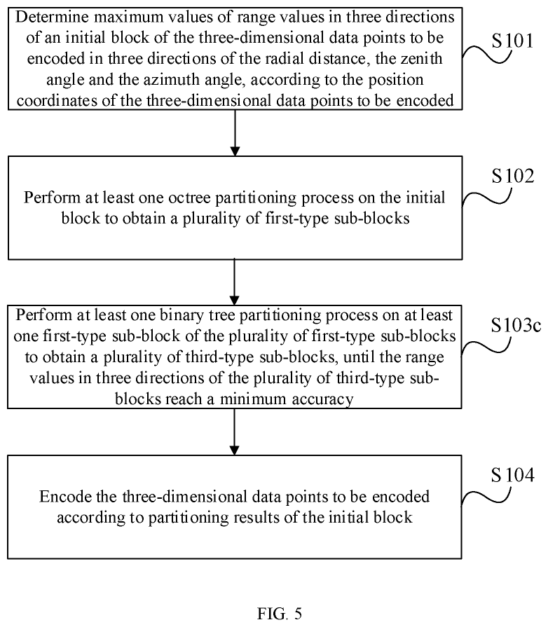

FIG. 6 is a schematic flow chart of another exemplary three-dimensional data point encoding method. Based on the embodiments in FIG. 2A to FIG. 5, FIG. 6 shows a possible implementation of S104. As shown in FIG. 6, the example implementation of S104 includes S104′.

In S104′, the situations of the partitioning processes are encoded in sequence according to the partitioning order and the situations of the sub-blocks obtained by each partitioning process containing three-dimensional data points. In this disclosure, the situation of a block/sub-block containing three-dimensional data points refers to how the block/sub-block contains three-dimensional data points, such as whether the block/sub-block contains one or more three-dimensional data points and/or how many three-dimensional data points does the block/sub-block contains, and is also referred to as a “point-containing situation” of the block/sub-block.

In one embodiment, for each partitioning process, according to the situations of the three-dimensional data points contained in the sub-blocks obtained by the partitioning process, a code stream corresponding to the current partitioning process may be obtained, and then the code streams corresponding to the partitioning processes may be encoded in sequence according to the partitioning order.

In one embodiment, for each partitioning process, according to the situation of the sub-blocks obtained by the partitioning process containing three-dimensional data points, the code stream corresponding to the current partitioning process may be obtained by:

according to the situation of the sub-blocks obtained by the partitioning process containing three-dimensional data points, obtaining a bitstream corresponding to each sub-block where each sub-block corresponds to one bit and bit values of the sub-blocks containing the three-dimensional data points is different from bit values of the sub-blocks not containing the three-dimensional data points; and generating the code stream corresponding to the current partitioning process according to the bit values corresponding to the sub-blocks. For each partitioning process, the bit values corresponding to the sub-blocks may be obtained, and the code stream corresponding to the current partitioning process may be obtained according to the bit values corresponding to the sub-blocks.

The number of bits of the code stream corresponding to each partitioning can be fixed to 8 bits, or can be determined according to the number of partitioned sub-blocks. For example, each octree partitioning may obtain eight sub-blocks, and the code stream corresponding to each octree partitioning may be identified by 8 bits subsequently. Each quadtree partitioning may obtain four sub-blocks, and the code stream corresponding to each quadtree partitioning may be identified by 4 bits. Each binary tree partitioning may obtain two sub-blocks, and the code stream corresponding to each binary tree partitioning may be identified by 2 bits.

In one embodiment, when the code stream corresponding to each partitioning is identified by 8 bits constantly, for each partitioning process, according to the bit values corresponding to the sub-blocks, the code stream corresponding to the current partitioning process may be obtained by:

when the octree partitioning is performed, determining the bit value of the 8 bits according to the three-dimensional data points contained in the eight sub-blocks obtained by the partitioning; when the quadtree partitioning is performed, determining the bit value of 4 bits among the 8 bits according to the three-dimensional data points contained in the four sub-blocks obtained by the partitioning, and determining the bit value of remaining 4 bits to be same as the bit values of the sub-block that does not contain the three-dimensional data point; when the binary tree partitioning is performed, determining the bit value of 2 bits among the 8 bits according to the three-dimensional data points contained in the two sub-blocks obtained by the partitioning, and determining the bit value of remaining 6 bits to be same as the bit values of the sub-block that does not contain the three-dimensional data point.

In another embodiment, when the number of bits in the code stream corresponding to each partitioning is determined according to the number of the sub-blocks obtained by the partitioning, for each partitioning process, according to the bit values corresponding to the sub-blocks, the code stream corresponding to the current partitioning process may be obtained by:

when the octree partitioning is performed, determining the number of bits in the code stream corresponding to the partitioning to be 8, and determining the bit values of the 8 bits according to the situation of the eight sub-blocks obtained by the partitioning containing three-dimensional data points;

when the quadtree partitioning is performed, determining the number of bits in the code stream corresponding to the partitioning to be 4, and determining the bit value of the 4 bits according to the situation of the four sub-blocks obtained by the partitioning containing three-dimensional data points; and

when the binary tree partitioning is performed, determining the number of bits in the code stream corresponding to the partitioning to be 2, and determining the bit value of the 2 bits according to the three-dimensional data points contained in the two sub-blocks obtained by the partitioning.

In one embodiment, the bit value corresponding to a sub-block containing the three-dimensional data points may be set as 1, and the bit value corresponding to a sub-block that does not contain the three-dimensional data points may be set as 0. In another embodiment, the bit value corresponding to a sub-block containing the three-dimensional data points may be set as 0, and the bit value corresponding to a sub-block that does not contain the three-dimensional data points may be set as 1. The present disclosure has no limit on this.

In one embodiment, optionally, when the range values in one direction or in two directions in the sub-blocks obtained by the partitioning reach the minimum accuracy, a first identifier may be encoded. The first identifier may be used to indicate a change of the partitioning mode where the partitioning mode includes the octree partitioning, the quadtree partitioning, or the binary tree partitioning, such that the decoding end may change the partitioning mode according to the first identifier.

When the range value in one direction of the sub-blocks obtained by the octree partitioning reaches the minimum accuracy or the range values in two directions of the sub-blocks obtained by the octree partitioning reach the minimum accuracy at the same time, the first identifier may have 8 bits, and the bit values of the 8 bits may be consistent with the bit values corresponding to the sub-blocks that do not contain three-dimensional data points. For example, when the bit value corresponding to the sub-block containing the three-dimensional point cloud data point is 1 and the bit value corresponding to the sub-block not containing the three-dimensional point cloud data point is 0, the first identifier is 00000000. For another example, when the bit value corresponding to the sub-block containing the three-dimensional point cloud data point is 0, and the bit value corresponding to the sub-block not containing the three-dimensional point cloud data point is 1, the first identifier is 11111111.

When the range values in two directions of the sub-blocks obtained by the quadtree partitioning reach the minimum accuracy, the first identifier may include 4 bits, and the bit values of the 4 bits may be consistent with the bit value corresponding to the sub-blocks that do not contain the three-dimensional data points. For example, when the bit value corresponding to the sub-block containing the three-dimensional point cloud data point is 1 and the bit value corresponding to the sub-block not containing the three-dimensional point cloud data point is 0, the first identifier is 0000. For another example, when the bit value corresponding to the sub-block containing the three-dimensional point cloud data point is 0, and the bit value corresponding to the sub-block not containing the three-dimensional point cloud data point is 1, the first identifier is 1111.

In one example, when the range value in one direction reaches the minimum accuracy first, the first identifier may be 00000000, and then when the range value in one of remaining directions reaches the minimum accuracy, the first identifier may be 0000.

In another example, when the range values in two directions reach the minimum accuracy simultaneously, the first identifier may be 00000000.

In another embodiment, when the range value in one direction reaches the minimum accuracy first, the first identifier may be 00000000.

In one embodiment, after the first identifier is encoded, a second identifier may be encoded further. The second identifier may be used to indicate the directions where the range values reach the minimum accuracy or the directions where the range values do not reach the minimum accuracy. Optionally, the second identifier may include 3 bits or 2 bits. In this way, the decoding end can determine which range value has reached the minimum accuracy and which range value has not reached the minimum accuracy according to the second identifier, thereby determining the direction of quadtree partitioning or binary tree partitioning.

For example, in one embodiment, the range values in the three directions may reach the minimum accuracy sequentially. When the range value in one direction reaches the minimum accuracy first, the second identifier may include three bits and may be 000, 001 or 010. 000, 001, and 010 respectively may correspond to the range value in one direction, indicating that the range value in the corresponding direction reaches the minimum accuracy. When the range value in one of remaining directions reaches the minimum accuracy, the second identifier may include two bits, and may be 00 or 01. 00 and 01 may respectively correspond to the range value of one of the remaining two directions.

In another embodiment, the range value in one direction may reach the minimum accuracy first, and the range values in the remaining two directions may reach the minimum accuracy at the same time. When the range value in one direction reaches the minimum accuracy first, the second identifier may include three bits, and may be 000, 001 or 010. 000, 001, and 010 respectively may correspond to the range value in one direction, indicating that the range value in the corresponding direction reaches the minimum accuracy.

In another embodiment, the range values in two directions may reach the minimum accuracy first, and the range value in the remaining direction may reach the minimum accuracy last. When the range values in two directions reach the minimum accuracy first, the second identifier may include three bits, and may be 100, 101, or 110. 100, 101, and 110 respectively may correspond to the range value in one direction, indicating that the range value in the corresponding direction does not reach the minimum accuracy.

In another embodiment, three bits may be used to represent the three directions in order, for example, represent the radial distance direction, the zenith angle direction, and the azimuth angle direction in turn. When the range value of a certain direction reaches the minimum accuracy, the bit position corresponding to the direction reaching the minimum accuracy may be set to 1, and the bit position that has not reached the minimum accuracy may be set to 0. For example, when the range value in the radial distance direction reaches the minimum accuracy first, the second identifier may be set to 100; when the range value in the zenith angle direction first reaches the minimum accuracy, the second identifier may be set to 010; when the range value in the azimuth angle direction first reaches the minimum accuracy, the second identifier may be set to 001; when the range values in both the radial distance direction and zenith angle directions reach the minimum accuracy It is 110. When the range values in the radial distance direction and the zenith angle direction both reach the minimum accuracy first, the second identifier may be set to 110; when the range values in the radial distance direction and the azimuth angle direction both reach the minimum accuracy first, the second identifier may be set to 101; when the range values in the zenith angle direction and the azimuth angle direction both reach the minimum accuracy first, the second identifier may be set to 011. Or, when the range value of a certain direction reaches the minimum accuracy, the bit position corresponding to the direction reaching the minimum accuracy may be set to 0, and the bit position that has not reached the minimum accuracy may be set to 1. For example, when the range value in the radial distance direction reaches the minimum accuracy first, the second identifier may be set to 011; when the range value in the zenith angle direction first reaches the minimum accuracy, the second identifier may be set to 101; when the range value in the azimuth angle direction first reaches the minimum accuracy, the second identifier may be set to 110. When the range values in the radial distance direction and the zenith angle direction both reach the minimum accuracy first, the second identifier may be set to 001; when the range values in the radial distance direction and the azimuth angle direction both reach the minimum accuracy first, the second identifier may be set to 010; when the range values in the zenith angle direction and the azimuth angle direction both reach the minimum accuracy first, the second identifier may be set to 100. The correspondence between the three bits and the three directions is not limited in the embodiment of the present disclosure, and any adjustment can be made.

Optionally, in one embodiment, a third identifier may be encoded. The third identifier may be used to indicate that the partitioning is completed. For example, when the range value in the last direction reaches the minimum accuracy, two bits 00 may be encoded to indicate that the partitioning is completed. For another example, when the range values in two directions reach the minimum accuracy last, four bits 0000 and two bits 10 may be encoded or four bits 0000 and two bits 11 may be encoded. The present disclosure has no limit on this as long as the completed partitioning can be distinguished.

In one embodiment, optionally, the number of the three-dimensional data points contained in the sub-block that contains the three-dimensional data points may be encoded further.

For example, when the sub-block contains one three-dimensional data point, 0 may be encoded to represent. When the sub-block contains N three-dimensional data points, 1 may be encoded and then N−1 may be encoded to represent.

Optionally, data for the decoding end to construct the initial block may be encoded into an information header.

In one embodiment, the minimum values after quantization, the maximum values after quantization of the position coordinates of the three-dimensional data points to be encoded, may be encoded; or

the minimum values before quantization, the maximum values before quantization of the position coordinates of the three-dimensional data points to be encoded, may be encoded; or

the minimum values before quantization, the maximum values after quantization of the position coordinates of the three-dimensional data points to be encoded, may be encoded; or

the minimum values after quantization, the maximum values before quantization of the position coordinates of the three-dimensional data points to be encoded, may be encoded.

In another embodiment, the minimum values after quantization, the maximum value of the maximum values after quantization of the position coordinates of the three-dimensional data points to be encoded, may be encoded; or

the minimum values before quantization, the maximum value of the maximum values before quantization of the position coordinates of the three-dimensional data points to be encoded, may be encoded; or

the minimum values before quantization, the maximum value of the maximum values after quantization of the position coordinates of the three-dimensional data points to be encoded, may be encoded; or

the minimum values after quantization, the maximum value of the maximum values before quantization of the position coordinates of the three-dimensional data points to be encoded, may be encoded.

In another embodiment, the minimum values after quantization, the minimum value of the maximum values after quantization of the position coordinates of the three-dimensional data points to be encoded, may be encoded; or

the minimum values before quantization, the minimum value of the maximum values before quantization of the position coordinates of the three-dimensional data points to be encoded, may be encoded; or

the minimum values before quantization, the minimum value of the maximum values after quantization of the position coordinates of the three-dimensional data points to be encoded, may be encoded; or

the minimum values after quantization, the minimum value of the maximum values before quantization of the position coordinates of the three-dimensional data points to be encoded, may be encoded.

Optionally, in some embodiments, at least one octree partitioning process may be performed on the initial block according to the coordinates of the center points, and at least one quadtree partitioning process and/or binary tree partitioning process may be performed on at least one first-type sub-block of the plurality of first-type sub-blocks according to the coordinates of the center points.

The coordinates of the center points may be obtained by:

obtaining the coordinates of the center points in the radial distance direction according to the maximum values and the minimum values of the blocks to be partitioned for each partitioning process in the radial distance direction;

obtaining the coordinates of the center points in the zenith angle direction according to the maximum values and the minimum values of the blocks to be partitioned for each partitioning process in the zenith angle direction; and

obtaining the coordinates of the center points in the radial direction according to the maximum values and the minimum values of the blocks to be partitioned for each partitioning process in the azimuth angle direction.

The coordinates of the center points in the radial distance direction may be obtained according to

$${r}_{mid} = \frac{{r}_{min} + {r}_{max}}{2} ,$$

and/or, the coordinates of the center points in the zenith angle direction may be obtained according to

$${θ}_{mid} = \frac{{θ}_{min} + {θ}_{max}}{2} ,$$

and/or the coordinates of the center points in the azimuth angle direction may be obtained according to

$${φ}_{mid} = \frac{{φ}_{min} + {φ}_{max}}{2} .$$

(r_{mid}, θ_{mid}, φ_{mid}) is the coordinates of the center points. rₘᵢₙ is the minimum value of the blocks to be partitioned in the radial direction, rₘₐₓ is the maximum value of the blocks to be partitioned in the radial direction, θₘᵢₙ is the minimum value of the blocks to be partitioned in the zenith angle direction, θₘₐₓ is the maximum value of the blocks to be partitioned in the zenith angle direction, φₘᵢₙ is the minimum value of the blocks to be partitioned in the azimuth angle direction, φₘₐₓ is the maximum value of the blocks to be partitioned in the azimuth angle direction.

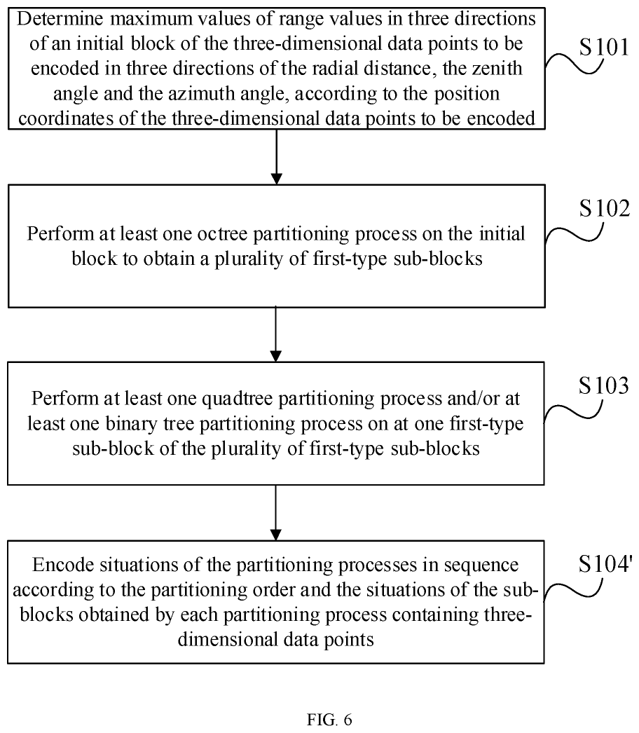

The present disclosure also provides a decoding method of three-dimensional data points. As illustrated in FIG. 7, in one embodiment, the method includes S701 to S704.

In S701, a code stream is obtained.

In S702, according to the code stream, the maximum values of the range values of the initial block in the radial distance direction, the zenith angle direction and the azimuth angle direction are obtained.

The range values of the initial block in the three directions may be same or different.

Optionally, the minimum values after the quantization and the maximum values after the quantization of the position coordinates in the three directions may be obtained according to the code stream.

The maximum values of the range values of the position coordinates in the radial distance direction, the zenith angle direction and the azimuth angle direction may be obtained according to the minimum values after the quantization and the maximum values after the quantization of the position coordinates in the three directions.

The maximum values of the range values of the initial block in the radial distance direction, the zenith angle direction and the azimuth angle direction may be obtained according to the maximum values of the range values of the position coordinates in the radial distance direction, the zenith angle direction and the azimuth angle direction.

In one embodiment, the maximum values of the range values of the initial block in the radial distance direction, the zenith angle direction and the azimuth angle direction may be obtained according to the maximum values of the range values of the position coordinates in the radial distance direction, the zenith angle direction and the azimuth angle direction, by:

in each direction, obtaining the value among the values that are the integer power of 2 and are greater than or equal to the maximum value of the range value of the position coordinates of the three-dimensional data point that is closest to the maximum value of the range value as the maximum value of the range value of initial block in the corresponding direction.

The minimum values after the quantization and the maximum values after the quantization of the position coordinates in the three directions may be obtained according to the code stream, by using, but not limited to following implementations.

The range values of the initial block constructed according to the following implementations may be different in the three directions.

In one implementation, the minimum values after the quantization and the maximum values after the quantization of the position coordinates in the three directions may be obtained directly according to the code stream.

In another implementation, the minimum values before the quantization and the maximum values after the quantization of the position coordinates in the three directions may be obtained; and then the minimum values after the quantization of the position coordinates in the three directions may be obtained according to the minimum values before the quantization of the position coordinates in the three directions and quantization step lengths in the three directions.

In another implementation, the minimum values after the quantization and the maximum values before the quantization of the position coordinates in the three directions may be obtained; and then the maximum values after the quantization of the position coordinates in the three directions may be obtained according to the maximum values before the quantization of the position coordinates in the three directions and quantization step lengths in the three directions.

The range values of the initial block constructed according to the following implementations may be same in the three directions.

In one implementation, the minimum values before the quantization and the maximum value of the maximum values after the quantization of the position coordinates in the three directions may be obtained directly according to the code stream; the minimum values after the quantization of the position coordinates in the three directions may be obtained according to the minimum values before the quantization of the position coordinates in the three directions and quantization step lengths in the three directions; and then the maximum value of the maximum values after the quantization may be used as the maximum values after quantization in the three directions.

In another implementation, the minimum values before the quantization and the minimum value of the maximum values after the quantization of the position coordinates in the three directions may be obtained directly according to the code stream; the minimum values after the quantization of the position coordinates in the three directions may be obtained according to the minimum values before the quantization of the position coordinates in the three directions and quantization step lengths in the three directions; and then the minimum value of the maximum values after the quantization may be used as the maximum values after quantization in the three directions.

In one implementation, the minimum values after the quantization and the maximum value of the maximum values after the quantization of the position coordinates in the three directions may be obtained directly according to the code stream; and then the maximum value of the maximum values after the quantization may be used as the maximum values after quantization in the three directions.

In another implementation, the minimum values after the quantization and the minimum value of the maximum values after the quantization of the position coordinates in the three directions may be obtained directly according to the code stream; and then the minimum value of the maximum values after the quantization may be used as the maximum values after quantization in the three directions.

In another implementation, the minimum values before the quantization and the maximum value of the maximum values before the quantization of the position coordinates in the three directions may be obtained directly according to the code stream; the minimum values after the quantization of the position coordinates in the three directions may be obtained according to the minimum values before the quantization of the position coordinates in the three directions and quantization step lengths in the three directions; the maximum value of the maximum values after the quantization of the position coordinates in the three directions may be obtained according to the maximum value of the maximum values before the quantization of the position coordinates in the three directions and quantization step lengths in the three directions; and then the maximum value of the maximum values after the quantization may be used as the maximum values after quantization in the three directions.

In another implementation, the minimum values before the quantization and the minimum value of the maximum values before the quantization of the position coordinates in the three directions may be obtained directly according to the code stream; the minimum values after the quantization of the position coordinates in the three directions may be obtained according to the minimum values before the quantization of the position coordinates in the three directions and quantization step lengths in the three directions; the minimum value of the maximum values after the quantization of the position coordinates in the three directions may be obtained according to the minimum value of the maximum values before the quantization of the position coordinates in the three directions and quantization step lengths in the three directions; and then the minimum value of the maximum values after the quantization may be used as the maximum values after quantization in the three directions.

In another implementation, the minimum values after the quantization and the maximum value of the maximum values before the quantization of the position coordinates in the three directions may be obtained directly according to the code stream; the maximum value of the maximum values after the quantization of the position coordinates in the three directions may be obtained according to the maximum value of the maximum values before the quantization of the position coordinates in the three directions and quantization step lengths in the three directions; and then the maximum value of the maximum values after the quantization may be used as the maximum values after quantization in the three directions.

In another implementation, the minimum values after the quantization and the minimum value of the maximum values before the quantization of the position coordinates in the three directions may be obtained directly according to the code stream; the minimum value of the maximum values after the quantization of the position coordinates in the three directions may be obtained according to the minimum value of the maximum values before the quantization of the position coordinates in the three directions and quantization step lengths in the three directions; and then the minimum value of the maximum values after the quantization may be used as the maximum values after quantization in the three directions.

In S703, at least one octree partitioning process is performed on the initial block to obtain a plurality of first-type sub-blocks.

The at least one octree partitioning process is performed on the initial block to obtain a plurality of first-type sub-blocks. For the octree partitioning process, reference can be made to the description about the encoding end.

In S704, at least one quadtree partitioning process and/or at least one binary tree partitioning process is performed on at least one first-type sub-block of the plurality of first-type sub-blocks.

In one embodiment, the range values of the three directions of the initial block are all different, performing the at least one quadtree partitioning process and/or at least one binary tree partitioning process on at least one first-type sub-block of the plurality of first-type sub-blocks may include: performing at least one quadtree partitioning process on at least one first-type sub-block of the plurality of first-type sub-blocks to obtain second-type sub-blocks, until the range values in two directions of the second-type sub-blocks reach the minimum accuracy; and performing at least one binary tree partitioning process on at least one second-type sub-block of the second-type sub-blocks to obtain third-type sub-blocks, until the range values in the three directions of the third-type sub-blocks reach the minimum accuracy.

Specifically, the first-type target sub-blocks may be determined according to the bit values corresponding to the plurality of first-type sub-blocks. Optionally, the bit values corresponding to the plurality of first-type sub-blocks may represent the three-dimensional data points contained in the plurality of first-type sub-blocks. At least one quadtree partitioning process may be performed on the first-type target sub-blocks. Second-type target sub-blocks may be determined according to the bit values corresponding to the second-type sub-blocks. Optionally, the bit values corresponding to the second-type sub-blocks may represent the three-dimensional data points contained in the second-type sub-blocks. At least one binary tree partitioning process may be performed on the second-type target sub-blocks.

For example, in one first-type sub-block of the last level obtained by the octree partitioning, the bit value of 1 may mean that the first-type sub-block contains three-dimensional data points, then one first-type sub-block with the bit value of 1 may be determined as a first-type target sub-block, or a bit value of 0 indicates that the first-type sub-block contains three-dimensional data points and one first-type sub-block with a bit value of 0 may be determined as the first-type target sub-block.

Optionally, a first identifier may be used to indicate the change of the partitioning mode, and the decoding end may determine the change of the partitioning mode according to the first identifier. The partitioning mode may include octree partitioning, quadtree partitioning, and binary tree partitioning. In this implementation, the first identifier indicates a change from octree partitioning to quadtree partitioning, and a change from quadtree partitioning to binary tree partitioning.

Optionally, a second identifier may be used to indicate the directions where the range values reach the minimum accuracy or the directions the range values do not reach the minimum accuracy. The decoding end can determine which range value reaches the minimum accuracy according to the second identifier, along which direction the quadtree partitioning is performed, which range values of two directions reach the minimum accuracy, and along which two directions the binary tree partitioning is performed. In another embodiment, according to the second identifier, the decoding end may determine in which two directions the range values do not reach the minimum accuracy, along which two directions the quadtree partitioning is performed, in which direction the range value does not reach the minimum accuracy, and along which direction the binary tree partitioning is performed.

For the specific partitioning of the quadtree and the binary tree, reference can be made to the relevant description for the encoding end, which will not be repeated here.

In another embodiment, when the range values in two directions of the initial block are equal and larger than the range value in another direction, performing the at least one quadtree partitioning process and/or at least one binary tree partitioning process on at least one first-type sub-block of the plurality of first-type sub-blocks to obtain the plurality of second-type sub-blocks, may include:

performing at least one quadtree partitioning process on at least one first-type sub-block of the plurality of first-type sub-blocks to obtain second-type sub-blocks, until the range values in three directions of the second-type sub-blocks reach the minimum accuracy.

Optionally, a first identifier may be used to indicate the change of the partitioning mode, and the decoding end may determine the change of the partitioning mode according to the first identifier. The partitioning mode may include octree partitioning, quadtree partitioning, and binary tree partitioning. In this implementation, the first identifier indicates a change from octree partitioning to quadtree partitioning.

Optionally, a second identifier may be used to indicate the directions where the range values reach the minimum accuracy or the directions the range values do not reach the minimum accuracy. The decoding end can determine which range value reaches the minimum accuracy according to the second identifier, along which direction the quadtree partitioning is performed, or may determine in which two directions the range values do not reach the minimum accuracy, along which two directions the quadtree partitioning is performed.

For the specific the quadtree partitioning, please refer to the relevant description on the encoding end, which will not be repeated here.

In another embodiment, when the range values in two directions of the initial block are equal and smaller than the range value in another direction, at least one binary tree partitioning process may be performed on at least one first-type sub-block of the plurality of first-type sub-blocks to obtain a plurality of third-type sub-blocks, until the range values in three directions of the plurality of third-type sub-blocks reach the minimum accuracy.

Optionally, a first identifier may be used to indicate the change of the partitioning mode, and the decoding end may determine the change of the partitioning mode according to the first identifier. The partitioning mode may include octree partitioning, quadtree partitioning, and binary tree partitioning. In this implementation, the first identifier indicates a change from octree partitioning to binary tree partitioning.

Optionally, a second identifier may be used to indicate the directions where the range values reach the minimum accuracy or the directions the range values do not reach the minimum accuracy. The decoding end can determine in which two directions the range values reach the minimum accuracy simultaneously according to the second identifier and along which two directions the binary tree partitioning is performed, or may determine in which direction the range value does not reach the minimum accuracy and along which direction the binary tree partitioning is performed.

Optionally, a third identifier may be used to determine the end of the partitioning.

For the specific the binary tree partitioning, please refer to the relevant description on the encoding end, which will not be repeated here.

In one embodiment, the range values of the initial block in the three directions may be same. Correspondingly, which of the quadtree partitioning or the binary tree partitioning is to be performed may be determined according to the first identifier and the second identifier, and the third identifier may be used to determine the end of the partitioning.

For example, in the process of octree partitioning, when decoding to that the first identifier is eight bits of 00000000, it may mean that the partitioning mode is changed. And then when decoding to the second identifier is three bits of 000, 001 or 010, 000, 001 and 010 may correspond to the range value in one direction of the three directions respectively, and the range value of the direction corresponding to the second identifier may be determined to reach the minimum accuracy according to the second identifier, and the quadtree partitioning may be performed. In the process of quadtree partitioning, when decoding to that the first identifier is four bits of 0000, it may mean that the partitioning mode is changed. And then when decoding to that the second identifier is two bits of 00 or 01, 00 and 01 may respectively correspond to the range value of one of the remaining two directions, and the range value of one of the remaining two directions corresponding to the second identifier may be determined to reach the minimum accuracy according to the second identifier. The binary tree partitioning may be performed.

For another example, in the process of octree partitioning, when decoding to that the first identifier is eight bits of 00000000, it may mean that the partitioning mode is changed. And then the three bits of the second identifier may be decoded. The second identifier may be 000, 001 or 010. 000, 001 and 010 may correspond to the range value in one direction of the three directions respectively, and the range value of the direction corresponding to the second identifier may be determined to reach the minimum accuracy according to the second identifier, and the quadtree partitioning may be performed. In the process of quadtree partitioning, when the third identifier is decoded to be 000010 or 000011, the partitioning is determined to be completed.

For another embodiment, in the process of octree partitioning, when decoding to that the first identifier is eight bits of 00000000, it may mean that the partitioning mode is changed. And then the three bits of the second identifier may be decoded. The second identifier may be 100, 101 or 110. 100, 101 and 110 may correspond to the range value in one direction of the three directions respectively, and may indicate the range value of the direction corresponding to the second identifier does not reach the minimum accuracy according to the second identifier and the range values of two remaining directions reach the minimum accuracy simultaneously. Then the binary tree partitioning may be performed. In the process of binary tree partitioning, when the third identifier is decoded to be 00, the partitioning is determined to be completed.

For another embodiment, in the process of octree partitioning, when decoding to that the first identifier is eight bits of 00000000, it may mean that the partitioning mode is changed. And then the three bits of the second identifier may be decoded. The second identifier may be 100, 010, 110, 001, 110, 101 or 011. According to a value of one direction corresponding to one bit position, whether the range value in this direction reaches the minimum accuracy may be determined. For example, the first bit, the second bit and the third bit may represent x, y, and z sequentially. The bit position that the range value in the corresponding direction reaches the minimum accuracy may be set to 1, and the bit position that does not reach the minimum accuracy may be set to 0. For example, 100 means the range value in the radial distance direction reaches the minimum accuracy first; 010 indicates that the range value in the zenith angle direction reaches the minimum accuracy first; 001 indicates that the range value in the azimuth angle direction reaches the minimum accuracy first; 110 indicates that both the range values in the x and zenith angle directions reach the minimum accuracy, 101 indicates that both the range values in the x and azimuth angle directions reach the minimum accuracy, 011 means that both the range values in the y and azimuth angle directions have reached the minimum accuracy. Or, the bit position that the range value in the corresponding direction reaches the minimum accuracy may be set to 0, and the bit position that the range value in the corresponding direction does not reach the minimum accuracy may be set to 1. For example: 011 means the range value in the radial distance direction reaches the minimum accuracy first; 101 indicates that the range value in the zenith angle direction reaches the minimum accuracy first; 110 indicates that the range value in the azimuth angle direction reaches the minimum accuracy first; 001 indicates that both the range values in the x and zenith angle directions reach the minimum accuracy, 010 indicates that both the range values in the x and azimuth angle directions reach the minimum accuracy, 100 means that both the range values in the y and azimuth angle directions have reached the minimum accuracy. The correspondence between the three bits and the three directions is not limited in the embodiment, and any adjustment can be made.

The third identifier may be used to determine the end of the partitioning. For example, after the binary tree partitioning, when decoding to two bits of 00, the partitioning may be determined to be completed. For another example, after the quadtree partitioning, when decoding to four bits of 0000 and two bits of 10, or decoding to four bits of 0000 and two bits of 11, the partitioning may be determined to be completed.

In S705, the position coordinates of the three-dimensional data points to be decoded (also referred to as “target three-dimensional data points”) are obtained according to the positions of the sub-blocks obtained by partitioning.

Optionally, quantized position coordinates of the three-dimensional data points to be decoded may be obtained according to the positions of the sub-blocks obtained by partitioning; and then the inverse quantization may be performed on the quantized position coordinates, to obtain the position coordinates of the three-dimensional data points to be decoded before quantization.

In one embodiment, when the range values of the initial block constructed to divide the distribution of spatial three-dimensional data points in the three directions are different, inverse quantization which is inverse to the encoding end may be performed on the quantized position coordinates obtained by decoding, to obtain the position coordinates of the three-dimensional data points to be decoded before quantization.

In another embodiment, the initial block constructed to divide the distribution of spatial three-dimensional data points in the three directions may be determined according to the minimum values after quantization and the maximum value of the maximum values of the position coordinates in the three directions. Correspondingly, the position coordinates after quantization of the three-dimensional data points to be decoded may be obtained according to the position of the sub-blocks obtained by partitioning, and the ratio of the range values in the three directions of the final sub-blocks.

Optionally, first position coordinates of the three-dimensional data points to be decoded may be obtained according to the positions of the sub-blocks obtained by the partitioning, and the ratio of the minimum value of the range values of the final sub-blocks obtained by the partitioning to the range values in the other two directions, may be obtained respectively. The coordinate value of each coordinate in the remaining two directions may be multiplied by the ratio of the corresponding direction.

Then, the inverse quantization of the decoded coordinate values which is inverse to the encoding end can be performed to obtain the actual position coordinate values of all the three-dimensional data points.

In another embodiment, the initial block constructed to divide the distribution of spatial three-dimensional data points in the three directions may be determined according to the minimum values after quantization and the minimum value of the maximum values of the position coordinates in the three directions. Correspondingly, the position coordinates after quantization of the three-dimensional data points to be decoded may be obtained according to the position of the sub-blocks obtained by partitioning, and the ratio of the range values in the three directions of the final sub-blocks.

Optionally, first position coordinates of the three-dimensional data points to be decoded may be obtained according to the positions of the sub-blocks obtained by the partitioning, and the ratio of the minimum value of the range values of the final sub-blocks obtained by the partitioning to the range values in the other two directions, may be obtained respectively. The coordinate value of each coordinate in the remaining two directions may be multiplied by the ratio of the corresponding direction.

Then, the inverse quantization of the decoded coordinate values which is inverse to the encoding end can be performed to obtain the actual position coordinate values of all the three-dimensional data points.

In one embodiment, performing the inverse quantization on the position coordinates after quantization may include at least one of:

performing the inverse quantization on the radial distance of the position coordinates of the three-dimensional data points according to the quantization step length in the radial distance direction;

performing the inverse quantization on the zenith angle of the position coordinates of the three-dimensional data points according to the quantization step length in the zenith angle direction; or

performing the inverse quantization on the azimuth angle of the position coordinates of the three-dimensional data points according to the quantization step length in the azimuth angle direction.

Optionally, the inverse quantization may be performed on the radial distance of the position coordinates of the three-dimensional data points according to rᵢ=\hat{r}ᵢ×r_{Δ}, the inverse quantization may be performed on the zenith angle of the position coordinates of the three-dimensional data points according to θᵢ=\hat{θ}ᵢ×θ_{Δ}, the inverse quantization may be performed on the azimuth angle of the position coordinates of the three-dimensional data points according to φᵢ=\hat{φ}ᵢ×φ_{Δ}. rᵢ is a value of a radial distance of the i-th three-dimensional data point of of the three-dimensional data points after the inverse quantization, r_{Δ} is the quantization step length in the radial distance direction, \hat{r}ᵢ is a value of the radial distance of the i-th three-dimensional data point of of the three-dimensional data points after quantization, θᵢ is a value of a zenith angle of the i-th three-dimensional data point of of the three-dimensional data points after the inverse quantization, θ_{Δ} is the quantization step length in the zenith angle direction, \hat{θ}ᵢ is a value of the zenith angle of the i-th three-dimensional data point of of the three-dimensional data points after quantization, φᵢ is a value of an azimuth angle of the i-th three-dimensional data point of of the three-dimensional data points after the inverse quantization, φ_{Δ} is the quantization step length in the azimuth angle direction, \hat{φ}ᵢ is a value of the azimuth angle of the i-th three-dimensional data point of of the three-dimensional data points after quantization.

In another embodiment, performing the inverse quantization on the position coordinates after quantization may include at least one of:

performing the inverse quantization on the radial distance of the position coordinates of the three-dimensional data points according to the quantization step length in the radial distance direction and the minimum values of the three-dimensional data points before quantization in the radial distance direction;

performing the inverse quantization on the zenith angle of the position coordinates of the three-dimensional data points according to the quantization step length in the zenith angle direction and the minimum values of the three-dimensional data points before quantization in the zenith angle direction; or

performing the inverse quantization on the azimuth angle of the position coordinates of the three-dimensional data points according to the quantization step length in the azimuth angle direction and the minimum values of the three-dimensional data points before quantization in the azimuth angle direction.

Optionally, the inverse quantization may be performed on the radial distance of the position coordinates of the three-dimensional data points according to rᵢ=\hat{r}ᵢ×r_{Δ}+rₘᵢₙ, the inverse quantization may be performed on the zenith angle of the position coordinates of the three-dimensional data points according to θᵢ=\hat{θ}ᵢ×θ_{Δ}+θₘᵢₙ, the inverse quantization may be performed on the azimuth angle of the position coordinates of the three-dimensional data points according to φᵢ=\hat{φ}ᵢ×φ_{Δ}+φₘᵢₙ. rᵢ is a value of a radial distance of the i-th three-dimensional data point of of the three-dimensional data points after the inverse quantization, r_{Δ} is the quantization step length in the radial distance direction, \hat{r}ᵢ is a value of the radial distance of the i-th three-dimensional data point of of the three-dimensional data points after quantization, rₘᵢₙ is the minimum value of the three-dimensional data points in the radial distance direction before quantization, θᵢ is a value of a zenith angle of the i-th three-dimensional data point of of the three-dimensional data points after the inverse quantization, θ_{Δ} is the quantization step length in the zenith angle direction, \hat{θ}ᵢ is a value of the zenith angle of the i-th three-dimensional data point of of the three-dimensional data points after quantization, θₘᵢₙ is the minimum value of the three-dimensional data points in the zenith angle direction before quantization, φᵢ is a value of an azimuth angle of the i-th three-dimensional data point of of the three-dimensional data points after the inverse quantization, φ_{Δ} is the quantization step length in the azimuth angle direction, \hat{φ}ᵢ is a value of the azimuth angle of the i-th three-dimensional data point of of the three-dimensional data points after quantization, and φₘᵢₙ is the minimum value of the three-dimensional data points in the azimuth angle direction before quantization.

Optionally, the method may further include: decoding the number of three-bit data points in one sub-block containing three-dimensional data points. When the decoded value is 0, it may mean that the corresponding sub-block contains one three-dimensional data point. When the decoded value is 1, it may mean that the corresponding sub-block contains more than one three-dimensional data point, and then may decode the following bits. If the decoded value is N, it may be determined that the number of three-dimensional data points contained is N+1.

In some embodiments, the code stream may be obtained through the decoding end, and then the maximum values of the range values of the initial block in the radial distance direction, the zenith angle direction, and the azimuth angle direction may be determined. The initial block may be constructed according to the maximum values of the range values of the initial block in the radial distance direction, the zenith angle direction, and the azimuth angle direction or according to the maximum values and the minimum values of the range values of the initial block in the radial distance direction, the zenith angle direction, and the azimuth angle direction. The at least one octree partitioning process may be performed on the initial block to obtain the plurality of first-type sub-blocks. And then at least one quadtree partitioning process and/or binary tree partitioning process may be performed on at least one first-type sub-block of the plurality of first-type sub-blocks. The position coordinates of the three-dimensional data points to be decoded may be obtained according to the positions of the sub-blocks obtained by partitioning. Since it is a mixed partitioning of octree partitioning, quadtree partitioning, and binary tree partitioning, or a mixed partitioning of octree partitioning and quadtree partitioning, or a mixed partitioning of octree partitioning and a binary tree partitioning, the number of partitioning may be reduced and the decoding efficiency may be improved.

Following embodiments will be used as examples to illustrate the present disclosure.

In one embodiment, in the encoding end, the position coordinates of the three-dimensional data points of the point cloud in the spherical coordinate system may be quantized.

In one implementation, the minimum values and the maximum values of the three-dimensional data points of the point cloud in the radial distance direction, the zenith angle direction, and the azimuth angle direction.

The radial distance of the position coordinates of the three-dimensional data points may be quantized according to

$${\hat{r}}_{i} = Round ( \frac{( {r}_{i} - {r}_{min} )}{{r}_{Δ}} ) ,$$

and/or, the zenith angle of the position coordinates of the three-dimensional data points may be quantized according to

$${\hat{θ}}_{i} = Round ( \frac{{θ}_{i} - {θ}_{min}}{{θ}_{Δ}} ) ,$$

and/or the azimuth angle of the position coordinates of the three-dimensional data points may be quantized according to

$${\hat{φ}}_{i} = Round ( \frac{{φ}_{i} - {φ}_{min}}{{φ}_{Δ}} ) ,$$

wherein rᵢ is a value of a radial distance of the i-th three-dimensional data points of the three-dimensional data points before quantization, rₘᵢₙ is the minimum value of the three-dimensional data points in the radial distance direction before quantization, r_{Δ} is the quantization step length in the radial distance direction, \hat{r}ᵢ is a value of the radial distance of the i-th three-dimensional data point of of the three-dimensional data points after quantization, θᵢ is a value of a zenith angle of the i-th three-dimensional data point of of the three-dimensional data points before quantization, θₘᵢₙ is the minimum value of the three-dimensional data points in the zenith angle direction before quantization, θ_{Δ} is the quantization step length in the zenith angle direction, \hat{θ}ᵢ is a value of the zenith angle of the i-th three-dimensional data point of of the three-dimensional data points after quantization, φᵢ is a value of an azimuth angle of the i-th three-dimensional data point of of the three-dimensional data points before quantization, φₘᵢₙ is the minimum value of the three-dimensional data points in the azimuth angle direction before quantization, φ_{Δ} is the quantization step length in the azimuth angle direction, \hat{φ}ᵢ is a value of the azimuth angle of the i-th three-dimensional data point of of the three-dimensional data points after quantization, Round(x) is a Round function returning a value which is a result of rounding operation according to the specified number of decimal places.

The position coordinates after quantization may be encoded.

In one implementation, partitioning encoding may be performed on the position coordinates in the spherical coordinate system to compress the position coordinates. Partitioning encoding may be performed on the position coordinates in the spherical coordinate system in the radial distance direction, the zenith angle direction, and the azimuth angle direction. When the range values in the three directions are all smaller than the minimum accuracy, the partitioning may be completed. The binary code stream describing the partitioning of each sub-block in each level may be sent to an arithmetic encoding engine for arithmetic encoding. Then the number of the three-dimensional data points in each sub-block corresponding to the point cloud may be encoded, and the binary code stream may be sent to the arithmetic encoding engine for arithmetic encoding. Correspondingly, encoding of the position coordinates may be achieved.

Attribute value encoding may be performed.

In one implementation, LOD hierarchical encoding may be performed according to the sequence of the position coordinates encoding.

In another implementation, binarization may be performed according to attribute values corresponding to the sequence of the position coordinate encoding directly, and then the binary code stream obtained after the binarization may be sent to the arithmetic encoding engine for arithmetic encoding, thereby completing the attribute value encoding.

Optionally, in one implementation: the minimum value before quantization and the maximum value after quantization of the position coordinates of the three-dimensional data points to be encoded in the three directions may be encoded and written into the information header for use by the decoding end.

In another implementation, the minimum value before quantization and the maximum value before quantization of the position coordinates of the three-dimensional data point to be coded in the three directions may be encoded and written into the information header for use by the decoding end.

In the decoding end, the position coordinates may be decoded.

When decoding the code stream of the position coordinates, the maximum values of the three-dimensional data points in the three directions including the radial distance direction, the zenith angle direction and the azimuth angle direction may be obtained by decoding the information header, and then the maximum range values in the initial decoding partitioning process may be initialized according to the maximum values.

In one implementation of the partitioning process, the partitioning may be performed according to the decoded code stream information describing the partitioning, and the partitioning may be completed when the range values in the three directions are all smaller than the minimum accuracy.

In one implementation of decoding the three-dimensional data points in the point cloud, the number of the three-dimensional data points in each sub-blocks corresponding to the point cloud may be encoded.

In one implementation of the inverse quantization, the inverse quantization may be performed on the radial distance of the position coordinates of the three-dimensional data points according to rᵢ=\hat{r}ᵢ×r_{Δ}+rₘᵢₙ, the inverse quantization may be performed on the zenith angle of the position coordinates of the three-dimensional data points according to θᵢ=\hat{θ}ᵢ×θ_{Δ}+θₘᵢₙ, the inverse quantization may be performed on the azimuth angle of the position coordinates of the three-dimensional data points according to φᵢ=\hat{φ}ᵢ×φ_{Δ}+φₘᵢₙ. rᵢ is a value of a radial distance of the i-th three-dimensional data point of of the three-dimensional data points after the inverse quantization, r_{Δ} is the quantization step length in the radial distance direction, \hat{r}ᵢ is a value of the radial distance of the i-th three-dimensional data point of of the three-dimensional data points after quantization, rₘᵢₙ is the minimum value of the three-dimensional data points in the radial distance direction before quantization, θᵢ is a value of a zenith angle of the i-th three-dimensional data point of of the three-dimensional data points after the inverse quantization, θ_{Δ} is the quantization step length in the zenith angle direction, \hat{θ}ᵢ is a value of the zenith angle of the i-th three-dimensional data point of of the three-dimensional data points after quantization, θₘᵢₙ is the minimum value of the three-dimensional data points in the zenith angle direction before quantization, φᵢ is a value of an azimuth angle of the i-th three-dimensional data point of of the three-dimensional data points after the inverse quantization, φ_{Δ} is the quantization step length in the azimuth angle direction, \hat{φ}ᵢ is a value of the azimuth angle of the i-th three-dimensional data point of of the three-dimensional data points after quantization, and φₘᵢₙ is the minimum value of the three-dimensional data points in the azimuth angle direction before quantization.

The attribute code stream may be decoded.

In one implementation, corresponding to the encoding process, LOD hierarchical decoding may be performed according to the sequence of the position coordinate encoding. In another implementation, the binarized attribute values may be decoded according to the sequence of the position coordinate encoding, and then inverse binarization may be performed to obtain the corresponding attribute values.

In another embodiment, in the encoding end, the position coordinates of the three-dimensional data points of the point cloud in the spherical coordinate system may be quantized.

In one implementation, the minimum values and the maximum values of the three-dimensional data points of the point cloud in the radial distance direction, the zenith angle direction, and the azimuth angle direction.

The radial distance of the position coordinates of the three-dimensional data points may be quantized according to

$${\hat{r}}_{i} = Round ( \frac{( {r}_{i} - {r}_{min} )}{{r}_{Δ}} ) ,$$

and/or, the zenith angle of the position coordinates of the three-dimensional data points may be quantized according to

$${\hat{θ}}_{i} = Round ( \frac{( {θ}_{i} - {θ}_{min} )}{{θ}_{Δ}} ) ,$$

and/or the azimuth angle of the position coordinates of the three-dimensional data points may be quantized according to

$${\hat{φ}}_{i} = Round ( \frac{( {φ}_{i} - {φ}_{min} )}{{φ}_{Δ}} ) ,$$

wherein rᵢ is a value of a radial distance of the i-th three-dimensional data points of the three-dimensional data points before quantization, rₘᵢₙ is the minimum value of the three-dimensional data points in the radial distance direction before quantization, r_{Δ} is the quantization step length in the radial distance direction, \hat{r}ᵢ is a value of the radial distance of the i-th three-dimensional data point of of the three-dimensional data points after quantization, θᵢ is a value of a zenith angle of the i-th three-dimensional data point of of the three-dimensional data points before quantization, θₘᵢₙ is the minimum value of the three-dimensional data points in the zenith angle direction before quantization, θ_{Δ} is the quantization step length in the zenith angle direction, \hat{θ}ᵢ is a value of the zenith angle of the i-th three-dimensional data point of of the three-dimensional data points after quantization, φᵢ is a value of an azimuth angle of the i-th three-dimensional data point of of the three-dimensional data points before quantization, φₘᵢₙ is the minimum value of the three-dimensional data points in the azimuth angle direction before quantization, φ_{Δ} is the quantization step length in the azimuth angle direction, \hat{φ}ᵢ is a value of the azimuth angle of the i-th three-dimensional data point of of the three-dimensional data points after quantization, Round(x) is a Round function returning a value which is a result of rounding operation according to the specified number of decimal places.

The position coordinates after quantization may be encoded.

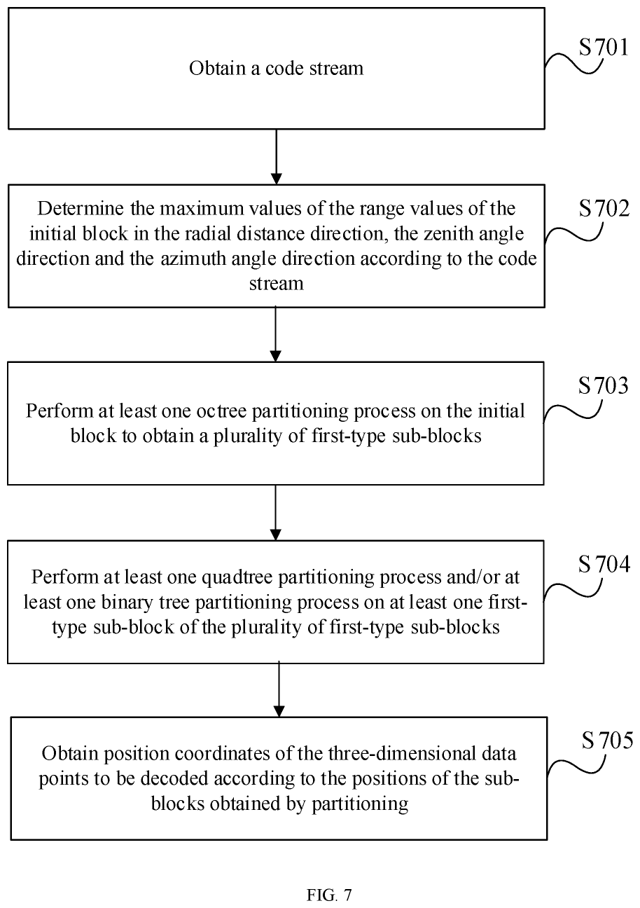

In one implementation, partitioning encoding may be performed on the position coordinates using the octree partitioning in the spherical coordinate system. One octree partitioning process is shown in FIG. 8.

partitioning encoding may be performed on the position coordinates in the spherical coordinate system along the three directions of the radial distance, the zenith angle, and the azimuth angle. In one implementation, initialization may be performed according to the maximum value in each direction. Each value after quantization is between 0 and Round((max−min)/Δ). Then the octree partitioning encoding may be performed. The octree partitioning process of each level may use the coordinates of the center point of the current block to perform the sub-block partitioning, and partition the current block to eight smaller sub-blocks through the center point. The coordinates of the center points in the radial distance direction may be obtained according to

$${r}_{mid} = \frac{{r}_{min} + {r}_{max}}{2} ,$$

and/or, the coordinates of the center points in the zenith angle direction may be obtained according to

$${θ}_{mid} = \frac{{θ}_{min} + {θ}_{max}}{2} ,$$

and/or the coordinates of the center points in the azimuth angle direction may be obtained according to

$${φ}_{mid} = \frac{{φ}_{min} + {φ}_{max}}{2} .$$

(r_{mid}, θ_{mid}, φ_{mid}) is the coordinates of the center points. rₘᵢₙ is the minimum value of the blocks to be partitioned in the radial direction, rₘₐₓ is the maximum value of the blocks to be partitioned in the radial direction, θₘᵢₙ is the minimum value of the blocks to be partitioned in the zenith angle direction, θₘₐₓ is the maximum value of the blocks to be partitioned in the zenith angle direction, φₘᵢₙ is the minimum value of the blocks to be partitioned in the azimuth angle direction, φₘₐₓ is the maximum value of the blocks to be partitioned in the azimuth angle direction.

In the octree partitioning process, the coordinate ranges corresponding to the eight sub-blocks obtained by the current octree partitioning process may be respectively: the coordinate range of the first sub-block is r≤r_{mid}, θ≤θ_{mid}, φ≤φ_{mid}, the coordinate value range of the second sub-block is r≤r_{mid}, θ≤θ_{mid}, φ>φ_{mid}, and the coordinate value range of the third sub-block is r≤r_{mid}, θ>θ_{mid}, φ≤φ_{mid}, the coordinate value range of the fourth sub-block is r≤r_{mid}, θ>θ_{mid}, φ>φ_{mid}, the coordinate value range of the fifth sub-block is r>r_{mid}, θ≤θ_{mid}, φ≤φ_{mid}, the coordinate value range of the sixth sub-block is r>r_{mid}, θ≤θ_{mid}, φ>φ_{mid}, the coordinate value range of the seventh sub-block is r>r_{mid}, θ>θ_{mid}, φ≤φ_{mid}, and the coordinate value range of the eighth sub-block is r>r_{mid}, θ>θ_{mid}, φ>φ_{mid}.

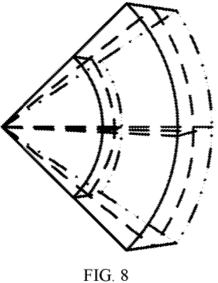

In the octree partitioning encoding process, it may be determined in turn which one of the eight sub-blocks each of the three-dimensional data points of the point cloud contained in the current block belong to, and then 8 bits may be used to encode the sub-block partitioning of the current block. When the current block contains three-dimensional data points of the point cloud, the corresponding bit will be set to 1, otherwise it will be set to 0. For example, when the third sub-block contains three-dimensional data points of the point cloud, the sixth sub-block contains three-dimensional data points of the point cloud, and the other sub-blocks do not contain three-dimensional data points, the encoded 8-bit binary code stream may be 0010 0100. The partitioning may be performed level by level in the order shown in FIG. 9.

In the encoding process, sub-block partitioning may be performed level by level and block by block, and the partitioning of each block may be encoded one by one. In the encoding process, since the number of times required to partition to the minimum accuracy in each direction is not necessarily the same, there may be three cases. In the first case, the range value in one direction reaches the minimum accuracy first. In the second case, the range values in two directions reach the minimum accuracy. In the third case, the range values in the three directions reach the minimum accuracy at the same time.

When the range value in one direction reaches the minimum accuracy first, the partitioning will not be performed along this direction in the subsequent partitioning process and the coordinate values in this direction may all be in the half of the interval less than or equal to the median value. For example, when the range value in the zenith angle direction first reaches the minimum accuracy, there may be only four possibilities for the partitioning process, which are case 1 (r≤r_{mid}, θ≤θ_{mid}, φ≤φ_{mid}); case 2 (r≤r_{mid}, θ>θ_{mid}, φ≤φ_{mid}), case 3 (r>r_{mid}, θ≤θ_{mid}, φ≤φ_{mid}), and case 4 (r>r_{mid}, θ>θ_{mid}, φ≤φ_{mid}). The 8-bit numbers corresponding to these four cases for descriptions of octree partitioning may be x0x0 x0x0, where x needs to be determined to be 0 or 1 according to whether the corresponding sub-block contains three-dimensional data points. When the range values in two directions reach the minimum accuracy first, the partitioning may not be performed on these two directions in the subsequent partitioning process, and the coordinate values in these two directions may all be set to half of the interval less than or equal to the median. For example, when the range values in the radial distance direction and the azimuth angle direction first reach the minimum accuracy, there may be only two possibilities for the partitioning process. They are case 1 (r≤r_{mid}, θ≤θ_{mid}, φ≤φ_{mid}) and case 2 (r≤r_{mid}, θ>θ_{mid}, φ≤φ_{mid}). The 8-bit numbers corresponding to these two cases for descriptions of octree partitioning may be x0x0 0000, where x needs to be determined to be 0 or 1 according to whether the previous two sub-blocks contain three-dimensional data points. When the range values in the three directions reach the minimum accuracy, the partitioning may not be performed on the three directions in the subsequent partitioning process and the tree partitioning encoding may end.

The number of three-dimensional data points of the point cloud may be encoded.

When the current leaf node block contains a three-dimensional data point of the point cloud, 0 may be encoded for representation. When the current leaf node block contains more than one three-dimensional data point of the point cloud, for example, when the current leaf node block contains n three-dimensional data points of the point cloud, 1 will be encoded first, and then the value (n−1) will be encoded. The binary bitstream that is previously encoded to represent the octree partitioning may be sent bit by bit to an arithmetic encoding engine for arithmetic encoding, and then the binary bitstream representing the number of three-dimensional data points of the point cloud in the leaf node block may be sent to the arithmetic encoding engine for arithmetic encoding. According to the above process, the encoding of the position coordinates in the point cloud data can be realized. Then the attribute information may be encoded using a similar process described in previous embodiments.

Optionally, in one implementation, the minimum values before quantization, and the maximum values after quantization of the position coordinates of the three-dimensional data points in the three directions may be encoded and written into the information header of the code stream file for use by the decoding end.

In another implementation, the minimum values before quantization, and the maximum values before quantization of the position coordinates of the three-dimensional data points in the three directions may be encoded and written into the information header of the code stream file for use by the decoding end.

In the decoding end, the position coordinates may be decoded.

When decoding the code stream of the position coordinates, the maximum values of the three-dimensional data points in the three directions including the radial distance direction, the zenith angle direction and the azimuth angle direction may be obtained by decoding the information header, and then the maximum range values in the initial decoding partitioning process may be initialized according to the maximum values.

In one implementation, the tree structure during the encoding may be constructed by decoding the 8-bit number sequentially. Each level of the octree partitioning process may use the coordinates of the center point of the current block to partition for sub-blocks, and may partition the current block to eight smaller sub-blocks using the center point. The coordinates of the center points in the radial distance direction may be (r_{mid}, θ_{mid}, φ_{mid}). In the octree partitioning process, the coordinate ranges corresponding to the eight sub-blocks obtained by the current octree partitioning process may be respectively: the coordinate range of the first sub-block is r≤r_{mid}, θ≤θ_{mid}, φ≤φ_{mid}, the coordinate value range of the second sub-block is r≤r_{mid}, θ≤θ_{mid}, φ>φ_{mid} and the coordinate value range of the third sub-block is r≤r_{mid}, θ>θ_{mid}, φ≤φ_{mid}, the coordinate value range of the fourth sub-block is r≤r_{mid}, θ>θ_{mid}, φ>φ_{mid}, the coordinate value range of the fifth sub-block is r>r_{mid}, θ≤θ_{mid}, φ≤φ_{mid}, the coordinate value range of the sixth sub-block is r>r_{mid}, θ≤θ_{mid}, φ>φ_{mid}, the coordinate value range of the seventh sub-block is r>r_{mid}, θ>θ_{mid}, φ≤φ_{mid}, and the coordinate value range of the eighth sub-block is r>r_{mid}, θ>θ_{mid}, φ>φ_{mid}. Each of the eight sub-blocks may correspond to one bit in the 8-bit number from high to low. When the corresponding bit is 1, the corresponding sub-block will continue to be partitioned, and when the corresponding bit is 0, the corresponding sub-block will not be further divided. When the range value in a certain direction of the partitioned sub-block reaches the minimum accuracy, the median value in this direction may be made equal to the coordinate value corresponding to the direction in which the minimum accuracy of the current block is reached, and the other directions may remain unchanged. When the range values in the three directions of the divided sub-blocks all reach the minimum accuracy, the partitioning may end.

Then the number of three-dimensional data points corresponding to the point cloud contained in the sub-block may be encoded. In a possible implementation, when a 0 is decoded, the current leaf node block may contain only one three-dimensional data point of the point cloud. When a 1 is decoded, the current leaf node block may contain more than one three-dimensional data point of the point cloud, and then the value (n−1) is decoded, indicating that the current leaf node block contains n three-dimensional data points of the point cloud. The position coordinates of the point cloud may be decoded by decoding the position coordinate bitstream sequentially. According to the above-mentioned scheme, the position coordinate code stream encoded by the coding scheme can be decoded. The attribute information code stream may be decoded according to the description in the previous embodiments.

In another embodiment, in the encoding end, the position coordinates of the three-dimensional data points of the point cloud in the spherical coordinate system may be quantized.

In one implementation, the minimum values and the maximum values of the three-dimensional data points of the point cloud in the radial distance direction, the zenith angle direction, and the azimuth angle direction may be obtained.

The radial distance of the position coordinates of the three-dimensional data points may be quantized according to

$${\hat{r}}_{i} = Round ( \frac{( {r}_{i} - {r}_{min} )}{{r}_{Δ}} ) ,$$

and/or, the zenith angle of the position coordinates of the three-dimensional data points may be quantized according to

$${\hat{θ}}_{i} = Round ( \frac{( {θ}_{i} - {θ}_{min} )}{{θ}_{Δ}} ) ,$$

and/or the azimuth angle of the position coordinates of the three-dimensional data points may be quantized according to

$${\hat{φ}}_{i} = Round ( \frac{( {φ}_{i} - {φ}_{min} )}{{φ}_{Δ}} ) ,$$

wherein rᵢ is a value of a radial distance of the i-th three-dimensional data points of the three-dimensional data points before quantization, rₘᵢₙ is the minimum value of the three-dimensional data points in the radial distance direction before quantization, r_{Δ} is the quantization step length in the radial distance direction, \hat{r}ᵢ is a value of the radial distance of the i-th three-dimensional data point of of the three-dimensional data points after quantization, θᵢ is a value of a zenith angle of the i-th three-dimensional data point of of the three-dimensional data points before quantization, θₘᵢₙ is the minimum value of the three-dimensional data points in the zenith angle direction before quantization, θ_{Δ} is the quantization step length in the zenith angle direction, \hat{θ}ᵢ is a value of the zenith angle of the i-th three-dimensional data point of of the three-dimensional data points after quantization, φᵢ is a value of an azimuth angle of the i-th three-dimensional data point of of the three-dimensional data points before quantization, φₘᵢₙ is the minimum value of the three-dimensional data points in the azimuth angle direction before quantization, φ_{Δ} is the quantization step length in the azimuth angle direction, \hat{φ}ᵢ is a value of the azimuth angle of the i-th three-dimensional data point of of the three-dimensional data points after quantization, Round(x) is a Round function returning a value which is a result of rounding operation according to the specified number of decimal places.

The position coordinates after quantization may be encoded.

In one implementation, partitioning encoding may be performed on the position coordinates using the octree partitioning in the spherical coordinate system. One octree partitioning process is shown in FIG. 8.

partitioning encoding may be performed on the position coordinates in the spherical coordinate system along the three directions of the radial distance, the zenith angle, and the azimuth angle. In one implementation, initialization may be performed according to the maximum value in each direction. Each value after quantization is between 0 and Round((max−min)/Δ). Then the octree partitioning encoding may be performed. The octree partitioning process of each level may use the coordinates of the center point of the current block to perform the sub-block partitioning, and partition the current block to eight smaller sub-blocks through the center point. The coordinates of the center points in the radial distance direction may be obtained according to

$${r}_{mid} = \frac{{r}_{min} + {r}_{max}}{2} ,$$

and/or, the coordinates of the center points in the zenith angle direction may be obtained according to

$${θ}_{mid} = \frac{{θ}_{min} + {θ}_{max}}{2} ,$$

and/or the coordinates of the center points in the azimuth angle direction may be obtained according to

$${φ}_{mid} = \frac{{φ}_{min} + {φ}_{max}}{2} .$$

(r_{mid} θ_{mid}, φ_{mid}) is the coordinates of the center points. rₘᵢₙ is the minimum value of the blocks to be partitioned in the radial direction, rₘₐₓ is the maximum value of the blocks to be partitioned in the radial direction, θₘᵢₙ is the minimum value of the blocks to be partitioned in the zenith angle direction, θₘₐₓ is the maximum value of the blocks to be partitioned in the zenith angle direction, φₘᵢₙ is the minimum value of the blocks to be partitioned in the azimuth angle direction, φₘₐₓ is the maximum value of the blocks to be partitioned in the azimuth angle direction.

In the octree partitioning process, the coordinate ranges corresponding to the eight sub-blocks obtained by the current octree partitioning process may be respectively: the coordinate range of the first sub-block is r≤r_{mid}, θ≤θ_{mid}, φ≤φ_{mid}, the coordinate value range of the second sub-block is r≤r_{mid}, θ≤θ_{mid}, φ>φ_{mid}, and the coordinate value range of the third sub-block is r≤r_{mid}, θ>θ_{mid}, φ≤φ_{mid}, the coordinate value range of the fourth sub-block is r≤r_{mid}, θ>θ_{mid}, φ>φ_{mid}, the coordinate value range of the fifth sub-block is r>r_{mid}, θ≤θ_{mid}, φ≤φ_{mid}, the coordinate value range of the sixth sub-block is r>r_{mid}, θ≤θ_{mid}, φ>φ_{mid}, the coordinate value range of the seventh sub-block is r>r_{mid}, θ>θ_{mid}, φ≤φ_{mid}, and the coordinate value range of the eighth sub-block is r>r_{mid}, θ>θ_{mid}, φ>φ_{mid}.

In the octree partitioning encoding process, it may be determined in turn which one of the eight sub-blocks each of the three-dimensional data points of the point cloud contained in the current block belong to, and then 8 bits may be used to encode the sub-block partitioning of the current block. When the current block contains three-dimensional data points of the point cloud, the corresponding bit will be set to 1, otherwise it will be set to 0. For example, when the third sub-block contains three-dimensional data points of the point cloud, the sixth sub-block contains three-dimensional data points of the point cloud, and the other sub-blocks do not contain three-dimensional data points, the encoded 8-bit binary code stream may be 0010 0100. The partitioning may be performed level by level in the order shown in FIG. 9.

In the encoding process, sub-block partitioning may be performed level by level and block by block, and the partitioning of each block may be encoded one by one. In the encoding process, since the number of times required to partition to the minimum accuracy in each direction is not necessarily the same, there may be three cases. In the first case, the range value in one direction reaches the minimum accuracy first. In the second case, the range values in two directions reach the minimum accuracy. In the third case, the range values in the three directions reach the minimum accuracy at the same time.

When the range value in one direction reaches the minimum accuracy first, the partitioning will not be performed along this direction in the subsequent partitioning process, and the partitioning encoding process may be performed along the remaining two directions. Correspondingly, the tree partitioning may change to the quadtree partitioning. For example, when the range value in the azimuth angle direction first reaches the minimum accuracy, the partitioning center may be (r_{mid}, θ_{mid}) and there may be only four possibilities for the partitioning process, which are case 1 (r≤r_{mid}, θ≤θ_{mid}); case 2 (r≤r_{mid}, θ>θ_{mid}), case 3 (r>r_{mid}, θ≤θ_{mid}), and case 4 (r>r_{mid}, θ>θ_{mid}). Only 4 bits may be needed to describe the current partitioning. For example, when the first sub-block and the fourth sub-block contain the three-dimensional data points of the point cloud, other sub-blocks do not contain the three-dimensional data points of the point cloud, the 4-bit binary code stream after encoding may be 1001. When the range values in two directions reach the minimum accuracy first, the partitioning may not be performed on these two directions but only performed on the remaining direction in the subsequent partitioning process. Correspondingly, the tree partitioning may change to the binary tree partitioning. For example, when the range values in the radial distance direction and the azimuth angle direction first reach the minimum accuracy, the partitioning center may be (θ_{mid}) and there may be only two possibilities for the partitioning process. They are case 1 (θ≤θ_{mid}) and case 2 (θ>θ_{mid}). Only 2 bits may be needed to describe the current partitioning. For example, when the first sub-block contains the three-dimensional data points of the point cloud and the second sub-block does not contain the three-dimensional data points of the point cloud, the 2-bit binary code stream after encoding may be 1001. When the range values in the three directions reach the minimum accuracy, the partitioning may not be performed on the three directions in the subsequent partitioning process and the tree partitioning encoding may end.

The number of three-dimensional data points of the point cloud may be encoded.

When the current leaf node block contains a three-dimensional data point of the point cloud, 0 may be encoded for representation. When the current leaf node block contains more than one three-dimensional data point of the point cloud, for example, when the current leaf node block contains n three-dimensional data points of the point cloud, 1 will be encoded first, and then the value (n−1) will be encoded. The binary bitstream that is previously encoded to represent the octree partitioning may be sent bit by bit to an arithmetic encoding engine for arithmetic encoding, and then the binary bitstream representing the number of three-dimensional data points of the point cloud in the leaf node block may be sent to the arithmetic encoding engine for arithmetic encoding. According to the above process, the encoding of the position coordinates in the point cloud data can be realized. Then the attribute information may be encoded using a similar process described in previous embodiments.

Optionally, in one implementation, the minimum values before quantization, and the maximum values after quantization of the position coordinates of the three-dimensional data points in the three directions may be encoded and written into the information header of the code stream file for use by the decoding end.

In another implementation, the minimum values before quantization, and the maximum values before quantization of the position coordinates of the three-dimensional data points in the three directions may be encoded and written into the information header of the code stream file for use by the decoding end.

In the decoding end, the initial block may be initialized.

In one implementation, the maximum values and the minimum values after quantization of the three-dimensional data points in the three directions including the radial distance direction, the zenith angle direction and the azimuth angle direction may be obtained by decoding the information header, and then the range values for initializing the octree partitioning process may be determined according to the maximum values and the minimum values.

In one implementation, the tree structure during the encoding may be constructed by decoding the 8-bit number sequentially. Each level of the octree partitioning process may use the coordinates of the center point of the current block to partition for sub-blocks, and may partition the current block to eight smaller sub-blocks using the center point. The coordinates of the center points in the radial distance direction may be (r_{mid}, θ_{mid}, φ_{mid}). In the octree partitioning process, the coordinate ranges corresponding to the eight sub-blocks obtained by the current octree partitioning process may be respectively: the coordinate range of the first sub-block is r≤r_{mid}, θ≤θ_{mid}, φ≤φ_{mid}, the coordinate value range of the second sub-block is r≤r_{mid}, θ≤θ_{mid}, φ>φ_{mid}, and the coordinate value range of the third sub-block is r≤r_{mid}, θ>θ_{mid}, φ≤φ_{mid}, the coordinate value range of the fourth sub-block is r≤r_{mid}, θ>θ_{mid}, φ>φ_{mid}, the coordinate value range of the fifth sub-block is r>r_{mid}, θ≤θ_{mid}, φ≤φ_{mid}, the coordinate value range of the sixth sub-block is r>r_{mid}, θ≤θ_{mid}, φ>φ_{mid}, the coordinate value range of the seventh sub-block is r>r_{mid}, θ>θ_{mid}, φ≤φ_{mid}, and the coordinate value range of the eighth sub-block is r>r_{mid}, θ>θ_{mid}, φ>φ_{mid}. Each of the eight sub-blocks may correspond to one bit in the 8-bit number from high to low. When the corresponding bit is 1, the corresponding sub-block will continue to be partitioned, and when the corresponding bit is 0, the corresponding sub-block will not be further partitioned. When the range value in one direction of the three directions of the partitioned sub-block reaches the minimum accuracy, 4 bits may be decoded each time. Each of the four sub-blocks may correspond to one bit in the 4-bit number from high to low. When the corresponding bit is 1, the corresponding sub-block will continue to be partitioned, and when the corresponding bit is 0, the corresponding sub-block will not be further partitioned. When the range values in two directions of the three directions of the partitioned sub-block reach the minimum accuracy, 2 bits may be decoded each time. Each of the two sub-blocks may correspond to one bit in the 2-bit number from high to low. When the corresponding bit is 1, the corresponding sub-block will continue to be partitioned, and when the corresponding bit is 0, the corresponding sub-block will not be further partitioned. When the range values in the three directions of the divided sub-blocks all reach the minimum accuracy, the partitioning may end.

Then the number of three-dimensional data points corresponding to the point cloud contained in the smallest sub-blocks may be decoded. In a possible implementation, when a 0 is decoded, the current leaf node block may contain only one three-dimensional data point of the point cloud. When a 1 is decoded, the current leaf node block may contain more than one three-dimensional data point of the point cloud, and then the value (n−1) is decoded, indicating that the current leaf node block contains n three-dimensional data points of the point cloud. The position coordinates of the point cloud may be decoded by decoding the position coordinate bitstream sequentially. Then the inverse quantization may be performed on the position coordinates obtained by decoding to obtain the position coordinates. According to the above-mentioned scheme, the position coordinate code stream encoded by the encoding scheme can be decoded. The attribute information code stream may be decoded according to the description in the previous embodiments.

In another embodiment, in the encoding end, the position coordinates of the three-dimensional data points of the point cloud in the spherical coordinate system may be quantized.

In one implementation, the minimum values and the maximum values of the three-dimensional data points of the point cloud in the radial distance direction, the zenith angle direction, and the azimuth angle direction may be obtained.

The radial distance of the position coordinates of the three-dimensional data points may be quantized according to

$${\hat{r}}_{i} = Round ( \frac{( {r}_{i} - {r}_{min} )}{{r}_{Δ}} ) ,$$

and/or, the zenith angle of the position coordinates of the three-dimensional data points may be quantized according to

$${\hat{θ}}_{i} = Round ( \frac{( {θ}_{i} - {θ}_{min} )}{{θ}_{Δ}} ) ,$$

and/or the azimuth angle of the position coordinates of the three-dimensional data points may be quantized according to

$${\hat{φ}}_{i} = Round ( \frac{( {φ}_{i} - {φ}_{min} )}{{φ}_{Δ}} ) ,$$

wherein rᵢ is a value of a radial distance of the i-th three-dimensional data points of the three-dimensional data points before quantization, rₘᵢₙ is the minimum value of the three-dimensional data points in the radial distance direction before quantization, r_{Δ} is the quantization step length in the radial distance direction, \hat{r}ᵢ is a value of the radial distance of the i-th three-dimensional data point of of the three-dimensional data points after quantization, θᵢ is a value of a zenith angle of the i-th three-dimensional data point of of the three-dimensional data points before quantization, θₘᵢₙ is the minimum value of the three-dimensional data points in the zenith angle direction before quantization, θ_{Δ} is the quantization step length in the zenith angle direction, \hat{θ}ᵢ is a value of the zenith angle of the i-th three-dimensional data point of of the three-dimensional data points after quantization, φᵢ is a value of an azimuth angle of the i-th three-dimensional data point of of the three-dimensional data points before quantization, φₘᵢₙ is the minimum value of the three-dimensional data points in the azimuth angle direction before quantization, φ_{Δ} is the quantization step length in the azimuth angle direction, \hat{φ}ᵢ is a value of the azimuth angle of the i-th three-dimensional data point of of the three-dimensional data points after quantization, Round(x) is a Round function returning a value which is a result of rounding operation according to the specified number of decimal places.

The position coordinates after quantization may be encoded.

In one implementation, partitioning encoding may be performed on the position coordinates using the octree partitioning in the spherical coordinate system. One octree partitioning process is shown in FIG. 8.

In one implementation, initialization may be performed according to the maximum value in each direction. Each value after quantization is between 0 and Round((max−min)/A). Then the partitioning encoding may be performed in the spherical coordinate system and each level partitioning may be performed by adopting the median value. Since the range values in the three directions may not reach the minimum accuracy in the same time, there may be several possibilities.

When the range values in the three directions do not reach the minimum accuracy, the octree partitioning process of each level may use the coordinates of the center point of the current block to perform the sub-block partitioning, and partition the current block to eight smaller sub-blocks through the center point. When (r_{mid}, θ_{mid}, φ_{mid}) is the coordinates of the center points, the coordinate range of the first sub-block is r≤r_{mid}, θ≤θ_{mid}, φ≤φ_{mid}, the coordinate value range of the second sub-block is r≤r_{mid}, θ≤θ_{mid}, φ>φ_{mid}, and the coordinate value range of the third sub-block is r≤r_{mid}, θ>θ_{mid}, φ≤φ_{mid}, the coordinate value range of the fourth sub-block is r≤r_{mid}, θ>θ_{mid}, φ>φ_{mid}, the coordinate value range of the fifth sub-block is r>r_{mid}, θ≤θ_{mid}, φ≤φ_{mid}, the coordinate value range of the sixth sub-block is r>r_{mid}, θ≤θ_{mid}, φ>φ_{mid}, the coordinate value range of the seventh sub-block is r>r_{mid}, θ>θ_{mid}, φ≤φ_{mid}, and the coordinate value range of the eighth sub-block is r>r_{mid}, θ>θ_{mid}, φ>φ_{mid}.

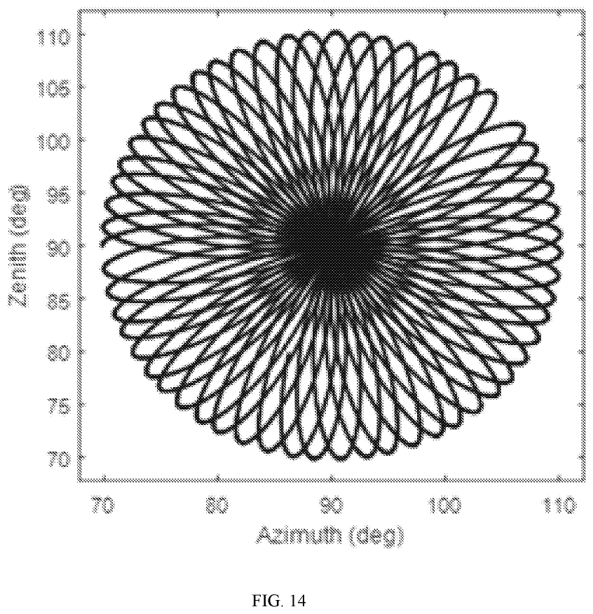

In the octree partitioning encoding process, it may be determined in turn which one of the eight sub-blocks each of the three-dimensional data points of the point cloud contained in the current block belong to, and then 8 bits may be used to encode the sub-block partitioning of the current block. When the current block contains three-dimensional data points of the point cloud, the corresponding bit will be set to 1, otherwise it will be set to 0. For example, when the third sub-block contains three-dimensional data points of the point cloud, the sixth sub-block contains three-dimensional data points of the point cloud, and the other sub-blocks do not contain three-dimensional data points, the encoded 8-bit binary code stream may be 0010 0100. The partitioning may be performed level by level in the order shown in FIG. 14.

When the range value in one direction reaches the minimum accuracy first, 8 bits may be encoded to 0, that is, encoded to 0000 0000, for representation, and then 3 bits may be encoded to indicate which direction of the three directions reaches the minimum accuracy first. For example, one possible correspondence may be: 000 indicates that the range value in the radial distance direction reaches the minimum accuracy first, 001 indicates that the range value in the zenith angle direction reaches the minimum accuracy first, and 010 indicates that the range value in the azimuth angle direction reaches the minimum accuracy first. Subsequently, the quadtree partitioning encoding may be performed in the two directions in which the range values do not reach the minimum accuracy. For example, when the range value in the azimuth angle direction first reaches the minimum accuracy, 3 bits of 010 may be encoded and the partitioning center may be (r_{mid}, θ_{mid}). There may be only four possibilities for the partitioning process, which are case 1 (r≤r_{mid}, θ≤θ_{mid}); case 2 (r≤r_{mid}, θ>θ_{mid}), case 3 (r>r_{mid}, θ≤θ_{mid}) and case 4 (r>r_{mid}, θ>θ_{mid}). Only 4 bits may be needed to describe the current partitioning. For example, when the first sub-block and the fourth sub-block contain the three-dimensional data points of the point cloud, other sub-blocks do not contain the three-dimensional data points of the point cloud, the 4-bit binary code stream after encoding may be 1001. Subsequently, the quadtree partitioning may be performed level by level, and the partitioning of each block may be encoded. There may be two cases where the range values reach the minimum accuracy.

In the first case, The range value in another direction of the remaining two directions reaches the minimum accuracy. 4 bits may be encoded to 0, that is, encoded to 0000, for representation first, and then 2 bits may be encoded to indicate which direction of the remaining two directions reaches the minimum accuracy first. For example, one possible correspondence may be: 00 indicates that the range value in the first one of the remaining two directions in an order of the radial distance, the zenith angle, and the azimuth angle reaches the minimum accuracy first, and 01 indicates that the range value in the last one of the remaining two directions in an order of the radial distance, the zenith angle, and the azimuth angle reaches the minimum accuracy first. For example, when the range value in the azimuth angle direction first reaches the minimum accuracy and then the range value in the radial direction reaches the minimum accuracy, since the radial direction is the first one in the remaining two directions of the radial distance direction and the zenith angle direction in the order of the radial distance, the zenith angle, and the azimuth angle, 2 bits of 00 may be encoded to represent this and subsequently the binary tree partitioning and encoding may be performed in a remaining direction in which the range value does not reach the minimum accuracy. The partitioning center may be (θ_{mid}) and there may be only two possibilities for the partitioning process. They are case 1 (θ≤θ_{mid}) and case 2 (θ>θ_{mid}). Only 2 bits may be needed to describe the current partitioning. For example, when the first sub-block contains the three-dimensional data points of the point cloud and the second sub-block does not contain the three-dimensional data points of the point cloud, the 2-bit binary code stream after encoding may be 10. Subsequently, the binary tree partitioning of the initial block may be performed level by level, and the partitioning of each cuboid block may be coded one by one, until the range value in the remaining direction also reaches the minimum accuracy. Two bits of 00 may indicate the tree partitioning may end.

In the second case, the range values in the remaining two directions reach the minimum accuracy simultaneously, and the range values in the three directions all reach the minimum accuracy correspondingly when combining the direction in which the range value reaches the minimum accuracy first. In one possible implementation, 4 bits may be encoded to 0, that is, encoded to 0000, for representation first, and then 2 bits of 00 may be encoded to indicate the end of the partitioning encoding.

When the range values in two directions reach the minimum accuracy first, in one possible implementation, 8 bits may be encoded to 0, that is, 0000 0000, for representation, and then 3 bits may be encoded to indicate which remaining direction of the three directions does not reach the minimum accuracy. For example, one possible correspondence may be: 100 indicates that the range value in the radial distance direction does not reach the minimum accuracy first, 101 indicates that the range value in the zenith angle direction does not reach the minimum accuracy first, and 110 indicates that the range value in the azimuth angle direction does not reach the minimum accuracy first. Subsequently, the binary tree partitioning and encoding may be performed in the remaining direction in which the range values do not reach the minimum accuracy. For example, when the range values in the radial distance direction and the zenith angle direction reach the minimum accuracy first, 3 bits of 110 may be encoded for description first, and the partitioning center may be (φₘᵢₙ). There may be only two possibilities for the partitioning process, which are case 1 (r≤r_{mid}, θ≤θ_{mid}, φ≤φ_{mid}) and case 2 (r>r_{mid}, θ≤θ_{mid}, φ>φ_{mid}). Only 2 bits may be needed to describe the current partitioning. For example, when the first sub-block contains the three-dimensional data points of the point cloud and the second sub-block does not contain the three-dimensional data points of the point cloud, the 2-bit binary code stream after encoding may be 10. Subsequently, the binary tree partitioning may be performed level by level, and the partitioning of each cuboid block may be coded one by one, until the range value in the remaining direction also reaches the minimum accuracy. Two bits of 00 may indicate the tree partitioning may end.

When the range values in the three directions reach the minimum accuracy at the same time, 8 bits may be encoded to 0, that is, 0000 0000, for representation, and then 3 bits may be encoded to 111, for indicating that the block partitioning may end.

The number of three-dimensional data points of the point cloud may be encoded.

When the current leaf node block contains a three-dimensional data point of the point cloud, 0 may be encoded for representation. When the current leaf node block contains more than one three-dimensional data point of the point cloud, for example, when the current leaf node block contains n three-dimensional data points of the point cloud, 1 will be encoded first, and then the value (n−1) will be encoded. The binary bitstream that is previously encoded to represent the octree partitioning may be sent bit by bit to an arithmetic encoding engine for arithmetic encoding, and then the binary bitstream representing the number of three-dimensional data points of the point cloud in the leaf node block may be sent to the arithmetic encoding engine for arithmetic encoding. According to the above process, the encoding of the position coordinates in the point cloud data can be realized. Then the attribute information may be encoded using a similar process described in previous embodiments.

In the decoding end, the maximum value of the maximum values of the three-dimensional data points in the three directions or the minimum value of the maximum values of the three-dimensional data points in the three directions may be obtained by decoding the information header, and then the range values of the blocks in the tree partitioning may be initialized according to the maximum value and the minimum value.

The octree partitioning may be used for decoding first and the tree structure during the encoding may be constructed by decoding the 8-bit number sequentially. Each level of the octree partitioning process may use the coordinates of the center point of the current block to partition for sub-blocks, and may partition the current block to eight smaller sub-blocks using the center point. After the sub-block partitioning, the decoded 8 bits may be used to determine sub-blocks containing the three-dimensional data points of the point cloud. For one sub-block, when the corresponding one bit is 1, the sub-block may contain the three-dimensional data points of the point cloud and may be partitioned further; when the corresponding one bit is 0, the sub-block may not contain the three-dimensional data points of the point cloud and may not be partitioned further. Arithmetic decoding may be performed by every 8 bits, and there may be multiple cases when decoding to 8 bits of 0, that is, 0000 0000.

In one case, when decoded to 8 bits of 0, which is 0000 0000, then 3 bits may be decoded. When it is decoded to 000, 001, or 010, it may mean that partitioning is changed to quadtree partitioning. When it is decoded to 000, it may mean that the range value in the radial distance direction reaches the minimum accuracy first. When it is decoded to 001, it may mean that the range value in the zenith angle direction reaches the minimum accuracy first. When it is decoded to 010, it may mean that the range value in the azimuth angle direction reaches the minimum accuracy first. For example, when decoded to 8 bits of 0, which is 0000 0000, then 3 bits may be decoded. When the 3 bits are decoded to 010, the partitioning center may be (r_{mid}, θ_{mid}) and there may be only four possibilities for the partitioning process, which are case 1 (r≤r_{mid}, θ≤δ_{mid}); case 2 (r≤r_{mid}, θ>δ_{mid}), case 3 (r>r_{mid}, θ≤δ_{mid}), and case 4 (r>r_{mid}, θ>δ_{mid}). Only 4 bits may be needed to describe the current partitioning. Correspondingly the decoding may be performed by every 4 bits, and the decoded 4 bits may be used to determine sub-blocks containing the three-dimensional data points of the point cloud. For one sub-block, when the corresponding one bit is 1, the sub-block may contain the three-dimensional data points of the point cloud and may be partitioned further; when the corresponding one bit is 0, the sub-block may not contain the three-dimensional data points of the point cloud and may not be partitioned further. Arithmetic decoding may be performed by every 4 bits, and there may be multiple cases when decoding to 4 bits of 0, that is, 0000.

In one case, when decoded to 4 bits of 0, which is 0000, then 2 bits may be decoded. When it is decoded to 00 or 01, it may mean that the range value in one of previous remaining two directions reaches the minimum accuracy. When it is decoded to 00, it may mean that the range value in one of the remaining two directions which is located first in the order of the radial distance, the zenith angle and the azimuth angle reaches the minimum accuracy first. When it is decoded to 01, it may mean that the range value in one of the remaining two directions which is located last in the order of the radial distance, the zenith angle and the azimuth angle reaches the minimum accuracy. For example, when the range value in the azimuth angle direction first reaches the minimum accuracy and decoded to 4 bits of 0, which is 0000, 2 bits may be decoded. When it is decoded to 00, the range value in the radial direction reaches the minimum accuracy, since the radial direction is located first in the order of the radial distance, the zenith angle and the azimuth angle, the partitioning may change to binary tree partitioning. The partitioning center may be (θ_{mid}) and there may be only two possibilities for the subsequent partitioning process. There may be only two possibilities for the partitioning process, which are case 1 (r≤r_{mid}, θ≤θ_{mid}, φ≤φ_{mid}) and case 2 (r>r_{mid}, θ≤θ_{mid}, φ>φ_{mid}). Only 2 bits may be needed to describe the current partitioning. Correspondingly the decoding may be performed by every 2 bits, and the decoded 2 bits may be used to determine sub-blocks containing the three-dimensional data points of the point cloud. For one sub-block, when the corresponding one bit is 1, the sub-block may contain the three-dimensional data points of the point cloud and may be partitioned further; when the corresponding one bit is 0, the sub-block may not contain the three-dimensional data points of the point cloud and may not be partitioned further. Arithmetic decoding may be performed by every 2 bits, and when decoding to 2 bits of 0, that is, 000, the partitioning may end.

In another case, when decoded to 4 bits of 0, which is 0000, then 2 bits may be decoded. When it is decoded to 11, the range values in the remaining two directions may also reach the minimum accuracy, and the partitioning may end.

When decoded to 8 bits of 0, which is 0000 0000, then 3 bits may be decoded. When it is decoded to 100, 101, or 110, it may mean that partitioning is changed to binary tree partitioning. When it is decoded to 100, it may mean that the range value in the radial distance direction does not reach the minimum accuracy. When it is decoded to 101, it may mean that the range value in the zenith angle direction does not reach the minimum accuracy. When it is decoded to 110, it may mean that the range value in the azimuth angle direction does not reach the minimum accuracy And it indicates that the next code stream is obtained by performing the binary tree partitioning encoding in the remaining direction that does not reach the minimum accuracy. For example, when decoded to 8 bits of 0, which is 0000 0000, then 3 bits may be decoded. When the 3 bits are decoded to 110, it may indicate that the range value in the azimuth angle direction does not reach the minimum accuracy. The partitioning center may be (φ_{mid}) and there may be only two possibilities for the partitioning process, which are case 1 (r≤r_{mid}, θ≤θ_{mid}, φ≤φ_{mid}) and case 2 (r≤r_{mid}, θ≤θ_{mid}, φ>φ_{mid}). Only 2 bits may be needed to describe the current partitioning. Correspondingly the decoding may be performed by every 2 bits, and the decoded 2 bits may be used to determine sub-blocks containing the three-dimensional data points of the point cloud. For one sub-block, when the corresponding one bit is 1, the sub-block may contain the three-dimensional data points of the point cloud and may be partitioned further; when the corresponding one bit is 0, the sub-block may not contain the three-dimensional data points of the point cloud and may not be partitioned further. Arithmetic decoding may be performed by every 2 bits, and when decoding to 2 bits of 0, that is, 000, the partitioning may end.

When decoded to 8 bits of 0, which is 0000 0000, then 3 bits may be decoded. When it is decoded to 111, it may indicate that the range values in the three directions of the radial distance, the zenith angle, and the azimuth angle direction reach the minimum accuracy in the same time and the block partitioning may end.

After the block partitioning encoding is end, since the maximum values of the range values and the minimum accuracy in the three directions of the radial distance, the zenith angle, and the azimuth angle direction are different, scale may need to be performed according to the minimum accuracy. Assuming the minimum accuracy in the radial distance direction during the partitioning is rₘᵢₙ′, the minimum accuracy in the zenith angle direction during the partitioning is θₘᵢₙ′, and the minimum accuracy in the azimuth angle direction during the partitioning is φₘᵢₙ′, the range values in the radial distance direction may be scaled according to

$$\hat{r} = {r}_{1} \times \frac{{r}_{min}^{′}}{{r}_{min - 1}}$$

where rₘᵢₙ₋₁ is the minimum accuracy in the radial distance r direction before scaling, r₁ is the coordinate value in the radial distance r direction before scaling, and \hat{r} is the coordinate value in the radial distance r direction after scaling; the range values in the zenith angle θ direction may be scaled according to

$$\hat{θ} = {θ}_{1} \times \frac{{θ}_{min}^{′}}{{θ}_{min - 1}}$$

where θₘᵢₙ₋₁ is the minimum accuracy in the zenith angle θ direction before scaling, θ₁ is the coordinate value in the zenith angle θ direction before scaling, and \hat{θ} is the coordinate value in the zenith angle θ direction after scaling; and the range values in the azimuth angle φ direction may be scaled according to

$$\hat{φ} = {φ}_{1} \times \frac{{φ}_{min}^{′}}{{φ}_{min - 1}}$$

where φₘₘ₋₁ is the minimum accuracy in the azimuth angle φ direction before scaling, φ₁ is the coordinate value in the azimuth angle φ direction before scaling, and \hat{φ} is the coordinate value in the azimuth angle φ direction after scaling.

Then the number of three-dimensional data points corresponding to the point cloud contained in the smallest sub-blocks may be decoded.

In a possible implementation, when a 0 is decoded, the current leaf node block may contain only one three-dimensional data point of the point cloud. When a 1 is decoded, the current leaf node block may contain more than one three-dimensional data point of the point cloud, and then the value (n−1) is decoded, indicating that the current leaf node block contains n three-dimensional data points of the point cloud. The position coordinates of the point cloud may be decoded by decoding the position coordinate bitstream sequentially. Then the inverse quantization may be performed on the position coordinates obtained by decoding to obtain the position coordinates. According to the above-mentioned scheme, the position coordinate code stream encoded by the encoding scheme can be decoded. The attribute information code stream may be decoded according to the description in the previous embodiments.

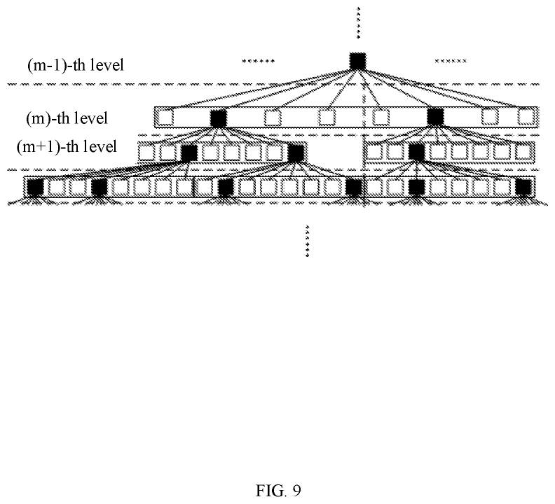

The present disclosure also provides a three-dimensional data point encoding device. In one embodiment as shown in FIG. 10, the three-dimensional data point encoding device includes a processor 1001 and a memory 1002.

The processor 1001 is configured to determine maximum values of range values in three directions of initial block of the three-dimensional data points to be encoded in three directions of the radial distance, the zenith angle and the azimuth angle.

The processor 1001 is further configured to perform at least one octree partitioning process on the initial block to obtain a plurality of first-type sub-blocks.

The processor 1001 is further configured to perform at least one quadtree partitioning process and or binary tree partitioning process on at one first-type sub-block of the plurality of first-type sub-blocks.

The processor 1001 is further configured to encode the three-dimensional data points to be encoded according to partitioning results of the initial block.

Optionally, the memory 1002 may be configured to store code stream obtained by encoding.

Optionally, when the range values in the three directions of the initial block are all different, the processor 1001 may be further configured to: perform at least one quadtree partitioning process on at least one first-type sub-block of the plurality of first-type sub-blocks to obtain second-type sub-blocks, until the range values in two directions of the second-type sub-blocks reach the minimum accuracy; and perform at least one binary tree partitioning process on at least one second-type sub-block of the second-type sub-blocks to obtain third-type sub-blocks, until the range values in the three directions of the third-type sub-blocks reach the minimum accuracy.

Optionally, when the range values in two directions of the initial block are equal and larger than the range value in another direction, the processor 1001 may be further configured to: perform at least one quadtree partitioning process on at least one first-type sub-block of the plurality of first-type sub-blocks to obtain second-type sub-blocks, until the range values in three directions of the second-type sub-blocks reach the minimum accuracy.

Optionally, when the range values in two directions of the initial block are equal and smaller than the range value in another direction, the processor 1001 may be further configured to: perform at least one binary tree partitioning process on at least one first-type sub-block of the plurality of first-type sub-blocks to obtain a plurality of third-type sub-blocks, until the range values in three directions of the plurality of third-type sub-blocks reach the minimum accuracy.

Optionally, the processor 1001 may be configured to: determine first-type target sub-bocks of the plurality of first-type sub-blocks. Optionally, the first-type target sub-blocks may be sub-blocks of the plurality of first-type sub-blocks whose range value in one direction reaches the minimum accuracy and contains three-dimensional data points. At least one quadtree partitioning process may be performed on the first-type target sub-blocks. Further, a second-type target sub-block of the second-type sub-blocks may be determined. Optionally, the second-type target sub-block may be one sub-block of the second-type sub-blocks whose range values in two direction reaches the minimum accuracy and contains three-dimensional data points. At least one binary tree partitioning process may be performed on the second-type target sub-block.

Optionally, the processor 1001 may be configured to: determine first-type target sub-bocks of the plurality of first-type sub-blocks. Optionally, the first-type target sub-blocks may be sub-blocks of the plurality of first-type sub-blocks whose range value in one direction reaches the minimum accuracy and contains three-dimensional data points. At least one quadtree partitioning process may be performed on the first-type target sub-blocks.

Optionally, the processor 1001 may be configured to: determine first-type target sub-bocks of the plurality of first-type sub-blocks. Optionally, the first-type target sub-blocks may be sub-blocks of the plurality of first-type sub-blocks whose range values in two directions reach the minimum accuracy and contains three-dimensional data points. At least one binary tree partitioning process may be performed on the first-type target sub-blocks.

Optionally, the processor 1001 may be configured to encode each partitioning process according to partition order and the situation of sub-blocks obtained by each partitioning containing the three-dimensional data points contained in.

Optionally, the processor 1001 may be configured to obtain the code stream corresponding to the current partitioning process according to the situation of the sub-blocks obtained by the partitioning process containing three-dimensional data points, and encode the code stream corresponding to each partitioning process according to the partitioning order.

Optionally, the processor 1001 may be configured to: according to the situation of the sub-blocks obtained by the partitioning process containing three-dimensional data points, obtain a bitstream corresponding to each sub-block where each sub-block corresponds to one bit and bit values of the sub-blocks including the three-dimensional data points is different from bit values of the sub-blocks not including the three-dimensional data points; and generate the code stream corresponding to the current partitioning process according to the bit values corresponding to the sub-blocks. For each partitioning process, the bit values corresponding to the sub-blocks may be obtained, and the code stream corresponding to the current partitioning process may be obtained according to the bit values corresponding to the sub-blocks.

Optionally, the code stream corresponding to each partitioning process may include 8 bits.

The processor 1001 may be configured to perform:

when the octree partitioning is performed, determining bit values of the 8 bits according to the situation of the eight sub-blocks obtained by the partitioning process containing three-dimensional data points;

when the quadtree partitioning is performed, determining bit values of 4 bits of the 8 bits according to the situation of the four sub-blocks obtained by the partitioning process containing three-dimensional data points, and determining bit values of remaining 4 bits to be same as the bit values of the sub-blocks which do not contain the three-dimensional data points;

when the binary tree partitioning is performed, determining bit values of 2 bits of the 8 bits according to the situation of the two sub-blocks obtained by the partitioning process containing three-dimensional data points, and determining bit values of remaining 6 bits to be same as the bit values of the sub-blocks which do not contain the three-dimensional data points.

Optionally, the processor 1001 may be configured to perform at least one of:

when the octree partitioning is performed and the code stream corresponding to each partitioning process includes 8 bits, determining bit values of the 8 bits according to the situation of the eight sub-blocks obtained by the partitioning process containing three-dimensional data points;

when the octree partitioning is performed and the code stream corresponding to each partitioning process includes 4 bits, determining bit values of the 4 bits according to the situation of the four sub-blocks obtained by the partitioning process containing three-dimensional data points; and

when the octree partitioning is performed and the code stream corresponding to each partitioning process includes 2 bits, determining bit values of the 2 bits according to the situation of the two sub-blocks obtained by the partitioning process containing three-dimensional data points.

Optionally, the bit value corresponding to one sub-block containing the three-dimensional data points of the point could may be 0, and the bit value corresponding to one sub-block not containing the three-dimensional data points of the point could may be 1.

Optionally, the bit value corresponding to one sub-block containing the three-dimensional data points of the point could may be 1, and the bit value corresponding to one sub-block not containing the three-dimensional data points of the point could may be 0.

Optionally, the processor 1001 may be further configured to: when the range values in one direction or in two directions in the sub-blocks obtained by the partitioning reach the minimum accuracy, encode a first identifier. The first identifier may be used to indicate a change of the partitioning mode where the partitioning mode includes the octree partitioning, the quadtree partitioning, or the binary tree partitioning, such that the decoding end may change the partitioning mode according to the first identifier.

Optionally, when the range value in one direction of the sub-blocks obtained by the octree partitioning reaches the minimum accuracy or the range values in two directions of the sub-blocks obtained by the octree partitioning reach the minimum accuracy at the same time, the first identifier may have 8 bits, and the bit values of the 8 bits may be consistent with the bit values corresponding to the sub-blocks that do not contain three-dimensional data points.

When the range values in two directions of the sub-blocks obtained by the quadtree partitioning reach the minimum accuracy, the first identifier may include 4 bits, and the bit values of the 4 bits may be consistent with the bit value corresponding to the sub-blocks that do not contain the three-dimensional data points.

Optionally, the processor 1001 may be further configured to: encode a second identifier. The second identifier may be used to indicate the directions where the range values reach the minimum accuracy or the directions where the range values do not reach the minimum accuracy.

Optionally, the second identifier may include 3 bits or 2 bits.

Optionally, the processor 1001 may be further configured to: encode a third identifier. The second identifier may be used to indicate the end of the partitioning.

Optionally, the processor 1001 may be further configured to: perform quantization on the position coordinates of the three-dimensional data points to be encoded in the spherical coordinate system; obtain the maximum values of the position coordinates of the three-dimensional data points to be encoded in the three directions according to the quantized position coordinates of the three-dimensional data points to be encoded; and determine the maximum values of the range values of the initial block of the three-dimensional data points to be encoded in the radial distance direction, the zenith angle direction, and the azimuth angle direction, according to the maximum values of the position coordinates of the three-dimensional data points to be encoded in the three directions.

Optionally, the processor 1001 may be further configured to: in each direction, determine a value among the values that are the integer power of 2 and are greater than or equal to the maximum value of the range value of the position coordinates of the three-dimensional data point that is closest to the maximum value of the range value as the maximum value of the range value of initial block in the corresponding direction.

Optionally, the processor 1001 may be further configured to:

quantize the radial distance of the position coordinates of the three-dimensional data points according to a quantization step length in the radial distance direction;

quantize the zenith angle of the position coordinates of the three-dimensional data points according to a quantization step length in the zenith angle direction; or

quantize the azimuth angle of the position coordinates of the three-dimensional data points according to a quantization step length in the azimuth angle direction.

Optionally, the processor 1001 may quantize the radial distance of the position coordinates of the three-dimensional data points according to

$$\hat{{r}_{i}} = Round ( \frac{{r}_{i}}{{r}_{Δ}} ) ,$$

and/or, quantize the zenith angle of the position coordinates of the three-dimensional data points according to

$${\hat{θ}}_{i} = Round ( \frac{{θ}_{i}}{{θ}_{Δ}} ) ,$$

and/or quantize the azimuth angle of the position coordinates of the three-dimensional data points according to

$${\hat{φ}}_{i} = Round ( \frac{{φ}_{i}}{{φ}_{Δ}} ) ,$$

where r is a value of a radial distance of the i-th three-dimensional data point of of the three-dimensional data points before quantization, r₆₆ is the quantization step length in the radial distance direction, \hat{r}ᵢ is a value of the radial distance of the i-th three-dimensional data point of of the three-dimensional data points after quantization, θᵢ is a value of a zenith angle of the i-th three-dimensional data point of of the three-dimensional data points before quantization, θ_{Δ} is the quantization step length in the zenith angle direction, \hat{θ}ᵢ is a value of the zenith angle of the i-th three-dimensional data point of of the three-dimensional data points after quantization, θ_{Δ} is a value of an azimuth angle of the i-th three-dimensional data point of of the three-dimensional data points before quantization, φ_{Δ} is the quantization step length in the azimuth angle direction, \hat{φ}ᵢ is a value of the azimuth angle of the i-th three-dimensional data point of of the three-dimensional data points after quantization, Round(x) is a Round function returning a value which is a result of rounding operation according to the specified number of decimal places.

Optionally, the processor 1001 may be further configured to:

quantize the radial distance of the position coordinates of the three-dimensional data points according to a quantization step length in the radial distance direction and a minimum value in the radial distance direction;

quantize the zenith angle of the position coordinates of the three-dimensional data points according to a quantization step length in the zenith angle direction and a minimum value in the zenith angle direction; or

quantize the azimuth angle of the position coordinates of the three-dimensional data points according to a quantization step length in the azimuth angle direction and a minimum value in the azimuth angle direction.

Optionally, the processor 1001 may quantize the radial distance of the position coordinates of the three-dimensional data points may be quantized according to

$$\hat{{r}_{i}} = Round ( \frac{( {r}_{i} - {r}_{min} )}{{r}_{Δ}} ) ,$$

and/or, quantize the zenith angle of the position coordinates of the three-dimensional data points according to

$${\hat{θ}}_{i} = Round ( \frac{( {θ}_{i} - {θ}_{min} )}{{θ}_{Δ}} ) ,$$

and/or quantize the azimuth angle of the position coordinates of the three-dimensional data points according to

$${\hat{φ}}_{i} = Round ( \frac{( {φ}_{i} - {φ}_{min} )}{{φ}_{Δ}} ) ,$$

where rᵢ is a value of a radial distance of the i-th three-dimensional data points of the three-dimensional data points before quantization, rₘᵢₙ is the minimum value of the three-dimensional data points in the radial distance direction before quantization, r_{Δ} is the quantization step length in the radial distance direction, \hat{r}ᵢ is a value of the radial distance of the i-th three-dimensional data point of of the three-dimensional data points after quantization, θᵢ is a value of a zenith angle of the i-th three-dimensional data point of of the three-dimensional data points before quantization, θₘᵢₙ is the minimum value of the three-dimensional data points in the zenith angle direction before quantization, θ_{Δ} is the quantization step length in the zenith angle direction, \hat{θ}ᵢ is a value of the zenith angle of the i-th three-dimensional data point of of the three-dimensional data points after quantization, φᵢ is a value of an azimuth angle of the i-th three-dimensional data point of of the three-dimensional data points before quantization, φₘᵢₙ is the minimum value of the three-dimensional data points in the azimuth angle direction before quantization, φ_{Δ} is the quantization step length in the azimuth angle direction, \hat{φ}ᵢ is a value of the azimuth angle of the i-th three-dimensional data point of of the three-dimensional data points after quantization, Round(x) is a Round function returning a value which is a result of rounding operation according to the specified number of decimal places.

Optionally, the processor 1001 may be further configured to encode the minimum values after quantization and the maximum values after quantization of the position coordinates of the three-dimensional data point to be coded in the three directions; or

encode the minimum values before quantization and the maximum values before quantization of the position coordinates of the three-dimensional data point to be coded in the three directions; or

encode the minimum values before quantization and the maximum values after quantization of the position coordinates of the three-dimensional data point to be coded in the three directions; or

encode the minimum values after quantization and the maximum values before quantization of the position coordinates of the three-dimensional data point to be coded in the three directions.

Optionally, the processor 1001 may be further configured to encode the minimum values after quantization and the maximum value of the maximum values after quantization of the position coordinates of the three-dimensional data point to be coded in the three directions; or

encode the minimum values before quantization and the maximum value of the maximum values before quantization of the position coordinates of the three-dimensional data point to be coded in the three directions; or

encode the minimum values before quantization and the maximum value of the maximum values after quantization of the position coordinates of the three-dimensional data point to be coded in the three directions; or

encode the minimum values after quantization and the maximum value of the maximum values before quantization of the position coordinates of the three-dimensional data point to be coded in the three directions.

Optionally, the processor 1001 may be further configured to encode the minimum values after quantization and the minimum value of the maximum values after quantization of the position coordinates of the three-dimensional data point to be coded in the three directions; or

encode the minimum values before quantization and the minimum value of the maximum values before quantization of the position coordinates of the three-dimensional data point to be coded in the three directions; or

encode the minimum values before quantization and the minimum value of the maximum values after quantization of the position coordinates of the three-dimensional data point to be coded in the three directions; or

encode the minimum values after quantization and the minimum value of the maximum values before quantization of the position coordinates of the three-dimensional data point to be coded in the three directions.

Optionally, the processor 1001 may be further configured to perform at least one octree partitioning process on the initial block according to the coordinates of the center points; and performing at least one quadtree partitioning process and or binary tree partitioning process on at one first-type sub-block of the plurality of first-type sub-blocks may include performing the at least one quadtree partitioning process and or binary tree partitioning process on at one first-type sub-block of the plurality of first-type sub-blocks according to the coordinates of the center points.

Optionally, the processor 1001 may be further configured to obtain the coordinates of the center points.

Optionally, the processor 1001 may be further configured to:

obtain the coordinates of the center points in the radial distance direction according to the maximum values and the minimum values of the blocks to be partitioned for each partitioning process in the radial distance direction;

obtain the coordinates of the center points in the zenith angle direction according to the maximum values and the minimum values of the blocks to be partitioned for each partitioning process in the zenith angle direction; and

obtain the coordinates of the center points in the radial direction according to the maximum values and the minimum values of the blocks to be partitioned for each partitioning process in the azimuth angle direction.

Optionally, the coordinates of the center points in the radial distance direction may be obtained according to

$${r}_{mid} = \frac{{r}_{min} + {r}_{max}}{2} ,$$

and/or, the coordinates of the center points in the zenith angle direction may be obtained according to

$${θ}_{mid} = \frac{{θ}_{min} + {θ}_{max}}{2} ,$$

and/or the coordinates of the center points in the azimuth angle direction may be obtained according to

$${φ}_{mid} = \frac{{φ}_{min} + {φ}_{max}}{2} ,$$

where (r_{mid}, θ_{mid}, φ_{mid}) is the coordinates of the center points. rₘᵢₙ is the minimum value of the blocks to be partitioned in the radial direction, rₘₐₓ is the maximum value of the blocks to be partitioned in the radial direction, θₘᵢₙ is the minimum value of the blocks to be partitioned in the zenith angle direction, θₘₐₓ is the maximum value of the blocks to be partitioned in the zenith angle direction, φₘᵢₙ is the minimum value of the blocks to be partitioned in the azimuth angle direction, φₘₐₓ is the maximum value of the blocks to be partitioned in the azimuth angle direction.

Optionally, the processor 1001 may be further configured to encode a number of the three-dimensional data points in one sub-block containing the three-dimensional data points.

Optionally, when the sub-block contains 1 three-dimensional data point, it may be encoded as 0, and when the sub-block contains N three-dimensional data points, it may be encoded as 1 and N−1.

Optionally, the initial block may be part of the sphere.

Optionally, a center of the sphere may be a position of an acquisition device of the three-dimensional data points.

Optionally, the acquisition device of the three-dimensional data points may be a laser radar, an optoelectric radar, or a laser scanner.

The device provided by the present embodiment may be used to perform any three-dimensional data point encoding method provided by various embodiments of the present disclosure shown in FIG. 2A to FIG. 6.

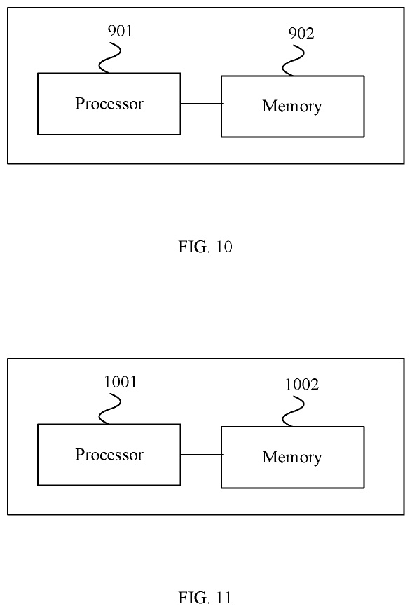

The present disclosure also provides a three-dimensional data point decoding device. As shown in FIG. 11, the device includes a processor 1101 and a memory 1102.

The processor 1101 is configured to obtain code streams.

The processor 1101 is further configured to determine the maximum values of the range values of the initial block in the radial distance direction, the zenith angle direction and the azimuth angle direction according to the code streams.

The processor 1101 is further configured to construct initial block according to the maximum values of the range values of the initial block in the radial distance direction, the zenith angle direction and the azimuth angle direction.

The processor 1101 is further configured to perform at least one octree partitioning process on the initial block to obtain a plurality of first-type sub-blocks.

The processor 1101 is further configured to perform at least one quadtree partitioning process and or binary tree partitioning process on at least one first-type sub-block of the plurality of first-type sub-blocks.

The processor 1101 is further configured to obtain position coordinates of the three-dimensional data points to be decoded according to the position of the sub-blocks obtained by partitioning.

Optionally, the memory 1102 may be configured to store code stream obtained by encoding.

Optionally, when the range values in the three directions of the initial block are all different, the processor 1101 may be further configured to: perform at least one quadtree partitioning process on at least one first-type sub-block of the plurality of first-type sub-blocks to obtain second-type sub-blocks, until the range values in two directions of the second-type sub-blocks reach the minimum accuracy; and perform at least one binary tree partitioning process on at least one second-type sub-block of the second-type sub-blocks to obtain third-type sub-blocks, until the range values in the three directions of the third-type sub-blocks reach the minimum accuracy.

Optionally, when the range values in two directions of the initial block are equal and larger than the range value in another direction, the processor 1101 may be further configured to: perform at least one quadtree partitioning process on at least one first-type sub-block of the plurality of first-type sub-blocks to obtain second-type sub-blocks, until the range values in three directions of the second-type sub-blocks reach the minimum accuracy.

Optionally, when the range values in two directions of the initial block are equal and smaller than the range value in another direction, the processor 1101 may be further configured to: perform at least one binary tree partitioning process on at least one first-type sub-block of the plurality of first-type sub-blocks to obtain a plurality of third-type sub-blocks, until the range values in three directions of the plurality of third-type sub-blocks reach the minimum accuracy.

Optionally, the processor 1101 may be configured to: determine first-type target sub-bocks of the plurality of first-type sub-blocks according to the bit values corresponding to the plurality of first-type sub-blocks. The first-type target sub-blocks may be sub-blocks of the plurality of first-type sub-blocks whose range value in one direction reaches the minimum accuracy and contains three-dimensional data points.

At least one quadtree partitioning process may be performed on the first-type target sub-blocks.

Further, a second-type target sub-block of the second-type sub-blocks may be determined according to the bit values corresponding to the second-type sub-blocks. The second-type target sub-blocks may be sub-blocks of the second-type sub-blocks whose range values in two direction reaches the minimum accuracy and contains three-dimensional data points.

At least one binary tree partitioning process may be performed on the second-type target sub-block.

Optionally, the processor 1101 may be configured to: determine first-type target sub-bocks of the plurality of first-type sub-blocks according to the bit values corresponding to the plurality of first-type sub-blocks. The first-type target sub-blocks may be sub-blocks of the plurality of first-type sub-blocks whose range value in one direction reaches the minimum accuracy and contains three-dimensional data points. At least one quadtree partitioning process may be performed on the first-type target sub-blocks.

Optionally, the processor 1101 may be configured to: determine first-type target sub-bocks of the plurality of first-type sub-blocks according to the bit values corresponding to the plurality of first-type sub-blocks. The first-type target sub-blocks may be sub-blocks of the plurality of first-type sub-blocks whose range value in one direction reaches the minimum accuracy and contains three-dimensional data points. At least one binary tree partitioning process may be performed on the first-type target sub-blocks.

Optionally, the processor 1101 may be further configured to: decode a first identifier. The first identifier may be used to indicate a change of the partitioning mode where the partitioning mode includes the octree partitioning, the quadtree partitioning, or the binary tree partitioning, such that the decoding end may change the partitioning mode according to the first identifier.

Optionally, the processor 1101 may be further configured to: decode a second identifier. The second identifier may be used to indicate the directions where the range values reach the minimum accuracy or the directions where the range values do not reach the minimum accuracy.

Optionally, the processor 1101 may be further configured to: decode a third identifier. The third identifier may be used to indicate the end of the partitioning.

Optionally, when the maximum values of the range values of the initial block in the three directions are equal, the processor 1101 may be configured to determine whether the quadtree partitioning or the binary tree partitioning is performed according to the first identifier and the second identifier, and determine the end of the partitioning according to the third identifier.

Optionally, the processor 1101 may be configured to obtain the minimum values after quantization and the maximum values after quantization of the position coordinates in the three directions according to the code streams; obtain the maximum values of the range values in the radial distance direction, in the zenith angle direction, and in the azimuth angle direction of the position coordinates, according to the minimum values after quantization and the maximum values after quantization of the position coordinates; and obtain the maximum values of the range values in the radial distance direction, in the zenith angle direction, and in the azimuth angle direction of the initial block, according to the maximum values of the range values in the radial distance direction, in the zenith angle direction, and in the azimuth angle direction of the position coordinates.

Optionally, the processor 1001 may be further configured to: in each direction, determine a value among the values that are the integer power of 2 and are greater than or equal to the maximum value of the range value of the position coordinates of the three-dimensional data point that is closest to the maximum value of the range value as the maximum value of the range value of initial block in the corresponding direction.

Optionally, the processor 1101 may be configured to obtain the minimum values before quantization and the maximum values before quantization of the position coordinates in the three directions according to the code streams; and obtain the minimum values after quantization and the maximum values after quantization of the position coordinates in the three directions, according to the minimum values before quantization and the maximum values before quantization of the position coordinates and the quantization step lengths in the three directions.

Optionally, the processor 1101 may be configured to obtain the minimum values before quantization and the maximum values after quantization of the position coordinates in the three directions according to the code streams; and obtain the minimum values after quantization of the position coordinates in the three directions, according to the minimum values before quantization of the position coordinates and the quantization step lengths in the three directions.

Optionally, the processor 1101 may be configured to obtain the minimum values after quantization and the maximum values before quantization of the position coordinates in the three directions according to the code streams; and obtain the maximum values after quantization of the position coordinates in the three directions, according to the maximum values before quantization of the position coordinates and the quantization step lengths in the three directions.

Optionally, the processor 1101 may be configured to obtain the minimum values before quantization and the maximum value of the maximum values after quantization of the position coordinates in the three directions according to the code streams; obtain the minimum values after quantization of the position coordinates in the three directions, according to the minimum values before quantization of the position coordinates and the quantization step lengths in the three directions; and determine the maximum value of the maximum values after quantization as the maximum values in the three directions.

Optionally, the processor 1101 may be configured to obtain the minimum values before quantization and the minimum value of the maximum values after quantization of the position coordinates in the three directions according to the code streams; obtain the minimum values after quantization of the position coordinates in the three directions, according to the minimum values before quantization of the position coordinates and the quantization step lengths in the three directions; and determine the minimum value of the maximum values after quantization as the maximum values in the three directions after quantization.

Optionally, the processor 1101 may be configured to obtain the minimum values after quantization and the maximum value of the maximum values after quantization of the position coordinates in the three directions according to the code streams; and determine the maximum value of the maximum values after quantization as the maximum values in the three directions after quantization.

Optionally, the processor 1101 may be configured to obtain the minimum values before quantization and the minimum value of the maximum values after quantization of the position coordinates in the three directions according to the code streams; and determine the minimum value of the maximum values after quantization as the maximum values in the three directions after quantization.

Optionally, the processor 1101 may be configured to obtain the minimum values before quantization and the maximum value of the maximum values before quantization of the position coordinates in the three directions according to the code streams; obtain the minimum values after quantization of the position coordinates in the three directions, according to the minimum values before quantization of the position coordinates and the quantization step lengths in the three directions; obtain the maximum value of the maximum values after quantization of the position coordinates in the three directions, according to the maximum value of the maximum values before quantization of the position coordinates and the quantization step lengths in the three directions; and determine the maximum value of the maximum values after quantization as the maximum values in the three directions after quantization.

Optionally, the processor 1101 may be configured to obtain the minimum values before quantization and the minimum value of the maximum values before quantization of the position coordinates in the three directions according to the code streams; obtain the minimum values after quantization of the position coordinates in the three directions, according to the minimum values before quantization of the position coordinates and the quantization step lengths in the three directions; obtain the minimum value of the maximum values after quantization of the position coordinates in the three directions, according to the maximum value of the maximum values before quantization of the position coordinates and the quantization step lengths in the three directions; and determine the minimum value of the maximum values after quantization as the maximum values in the three directions after quantization.

Optionally, the processor 1101 may be configured to obtain the minimum values after quantization and the maximum value of the maximum values before quantization of the position coordinates in the three directions according to the code streams; obtain the maximum value of the maximum values after quantization of the position coordinates in the three directions, according to the maximum value of the maximum values before quantization of the position coordinates and the quantization step lengths in the three directions; and determine the maximum value of the maximum values after quantization as the maximum values in the three directions after quantization.

Optionally, the processor 1101 may be configured to obtain the minimum values after quantization and the minimum value of the maximum values before quantization of the position coordinates in the three directions according to the code streams; obtain the minimum value of the maximum values after quantization of the position coordinates in the three directions, according to the minimum value of the maximum values before quantization of the position coordinates and the quantization step lengths in the three directions; and determine the maximum value of the minimum values after quantization as the maximum values in the three directions after quantization.

Optionally, the processor 1101 may be configured to obtain the position coordinates of the three-dimensional data points to be encoded according to the positions of the sub-blocks obtained by partitioning, and the ratio of the range values in the three directions of the sub-blocks obtained by the final partitioning.

Optionally, the processor 1101 may be configured to obtain first position coordinates of the three-dimensional data points to be encoded may be according to the positions of the sub-blocks obtained by the partitioning, and the ratio of the minimum values of the range values of the final sub-blocks obtained by the partitioning to the range values in the other two directions. The coordinate value of each coordinate in the remaining two directions may be multiplied by the ratio of the corresponding direction.

Optionally, the processor 1101 may be configured to obtain first position coordinates of the three-dimensional data points to be encoded may be according to the positions of the sub-blocks obtained by the partitioning, and the ratio of the maximum values of the range values of the final sub-blocks obtained by the partitioning to the range values in the other two directions. The coordinate value of each coordinate in the remaining two directions may be multiplied by the ratio of the corresponding direction.

Optionally, the processor 1101 may be further configured to decode the number of the three-dimensional data points in the sub-blocks which contain the three-dimensional data points.

Optionally, the processor 1101 may be further configured to perform at least one octree partitioning process on the initial block according to the coordinates of the center points; and perform at least one quadtree partitioning process and or binary tree partitioning process on at one first-type sub-block of the plurality of first-type sub-blocks according to the coordinates of the center points.

Optionally, the processor 1101 may be further configured to obtain the coordinates of the center points.

Optionally, the processor 1101 may be further configured to:

obtain the coordinates of the center points in the radial distance direction according to the maximum values and the minimum values of the blocks to be partitioned for each partitioning process in the radial distance direction;

obtain the coordinates of the center points in the zenith angle direction according to the maximum values and the minimum values of the blocks to be partitioned for each partitioning process in the zenith angle direction; and

obtain the coordinates of the center points in the radial direction according to the maximum values and the minimum values of the blocks to be partitioned for each partitioning process in the azimuth angle direction.

Optionally, the coordinates of the center points in the radial distance direction may be obtained according to

$${r}_{mid} = \frac{{r}_{min} + {r}_{max}}{2} ,$$

and/or, me coordinates of the center points in the zenith angle direction may be obtained according to

$${θ}_{mid} = \frac{{θ}_{min} + {θ}_{max}}{2} ,$$

and/or the coordinates of the center points in the azimuth angle direction may be obtained according to

$${φ}_{mid} = \frac{{φ}_{min} + {φ}_{max}}{2} ,$$

where (r_{mid}, θ_{mid}, φ_{mid}) is the coordinates of the center points. rₘᵢₙ is the minimum value of the blocks to be partitioned in the radial direction, rₘₐₓ is the maximum value of the blocks to be partitioned in the radial direction, θₘᵢₙ is the minimum value of the blocks to be partitioned in the zenith angle direction, θₘₐₓ is the maximum value of the blocks to be partitioned in the zenith angle direction, φₘᵢₙ is the minimum value of the blocks to be partitioned in the azimuth angle direction, φₘₐₓ is the maximum value of the blocks to be partitioned in the azimuth angle direction.

Optionally, the processor 1101 may be further configured to obtain the position coordinates after quantization of the three-dimensional data points to be encoded according to the positions of the sub-blocks obtained by partitioning; and perform inverse quantization on the position coordinates after quantization to obtain the position coordinates before quantization of the three-dimensional data points to be encoded.

Optionally, the processor 1101 may be further configured to:

perform the inverse quantization on the radial distance of the position coordinates of the three-dimensional data points according to the quantization step length in the radial distance direction;

perform the inverse quantization on the zenith angle of the position coordinates of the three-dimensional data points according to the quantization step length in the zenith angle direction; or

perform the inverse quantization on the azimuth angle of the position coordinates of the three-dimensional data points according to the quantization step length in the azimuth angle direction.

Optionally, the processor 1101 may be further configured such that the inverse quantization may be performed on the radial distance of the position coordinates of the three-dimensional data points according to rᵢ=\hat{r}ᵢ×r_{Δ}, and/or the inverse quantization may be performed on the zenith angle of the position coordinates of the three-dimensional data points according to θᵢ=\hat{θ}ᵢ×θ_{Δ}, and/or the inverse quantization may be performed on the azimuth angle of the position coordinates of the three-dimensional data points according to φᵢ=\hat{φ}ᵢ× φ_{Δ}. rᵢ is a value of a radial distance of the i-th three-dimensional data point of of the three-dimensional data points after the inverse quantization, r_{Δ} is the quantization step length in the radial distance direction, \hat{r}ᵢ is a value of the radial distance of the i-th three-dimensional data point of of the three-dimensional data points after quantization, θᵢ is a value of a zenith angle of the i-th three-dimensional data point of of the three-dimensional data points after the inverse quantization, θ_{Δ} is the quantization step length in the zenith angle direction, \hat{θ}ᵢ is a value of the zenith angle of the i-th three-dimensional data point of of the three-dimensional data points after quantization, φᵢ is a value of an azimuth angle of the i-th three-dimensional data point of of the three-dimensional data points after the inverse quantization, φ_{Δ} is the quantization step length in the azimuth angle direction, \hat{φ}ᵢ is a value of the azimuth angle of the i-th three-dimensional data point of of the three-dimensional data points after quantization.

Optionally, the processor 1101 may be further configured to:

perform the inverse quantization on the radial distance of the position coordinates of the three-dimensional data points according to the quantization step length in the radial distance direction and the minimum values of the three-dimensional data points before quantization in the radial distance direction;

perform the inverse quantization on the zenith angle of the position coordinates of the three-dimensional data points according to the quantization step length in the zenith angle direction and the minimum values of the three-dimensional data points before quantization in the zenith angle direction; or

perform the inverse quantization on the azimuth angle of the position coordinates of the three-dimensional data points according to the quantization step length in the azimuth angle direction and the minimum values of the three-dimensional data points before quantization in the azimuth angle direction.

Optionally, the processor 1101 may be further configured such that the inverse quantization may be performed on the radial distance of the position coordinates of the three-dimensional data points according to rᵢ=\hat{r}ᵢ×r_{Δ}+rₘᵢₙ, and/or the inverse quantization may be performed on the zenith angle of the position coordinates of the three-dimensional data points according to θᵢ=\hat{θ}ᵢ×θ_{Δ}+θₘᵢₙ, and/or the inverse quantization may be performed on the azimuth angle of the position coordinates of the three-dimensional data points according to φᵢ=\hat{φ}ᵢ×φ_{Δ}+φₘᵢₙ. rᵢ is a value of a radial distance of the i-th three-dimensional data point of of the three-dimensional data points after the inverse quantization, r_{Δ} is the quantization step length in the radial distance direction, \hat{r}ᵢ is a value of the radial distance of the i-th three-dimensional data point of of the three-dimensional data points after quantization, rₘᵢₙ is the minimum value of the three-dimensional data points in the radial distance direction before quantization, θᵢ is a value of a zenith angle of the i-th three-dimensional data point of of the three-dimensional data points after the inverse quantization, θ_{Δ} is the quantization step length in the zenith angle direction, \hat{θ}ᵢ is a value of the zenith angle of the i-th three-dimensional data point of of the three-dimensional data points after quantization, θₘᵢₙ is the minimum value of the three-dimensional data points in the zenith angle direction before quantization, φᵢ is a value of an azimuth angle of the i-th three-dimensional data point of of the three-dimensional data points after the inverse quantization, φ_{Δ} is the quantization step length in the azimuth angle direction, \hat{φ}ᵢ is a value of the azimuth angle of the i-th three-dimensional data point of of the three-dimensional data points after quantization, and φₘᵢₙ is the minimum value of the three-dimensional data points in the azimuth angle direction before quantization.

Optionally, the initial block may be part of the sphere.

Optionally, a center of the sphere may be a position of an acquisition device of the three-dimensional data points.

Optionally, the acquisition device of the three-dimensional data points may be a laser radar, an optoelectric radar, or a laser scanner.

The device provided by the present embodiment may be used to perform any three-dimensional data point decoding method provided by various embodiments of the present disclosure shown in FIG. 7.

The present disclosure also provides an encoder. The encoder includes a memory, a processor, and a program stored in the memory and configured to be executed by the processor. When the processor executes the program, any three-dimensional data point encoding method provided by various embodiments of the present disclosure shown in FIG. 2A to FIG. 6 may be achieved.

The present disclosure also provides a decoder. The encoder includes a memory, a processor, and a program stored in the memory and configured to be executed by the processor. When the processor executes the program, any three-dimensional data point encoding method provided by various embodiments of the present disclosure shown in FIG. 7 may be achieved.

In some embodiments, a three-dimensional data point may be any three-dimensional data points in point cloud data obtained by a ranging apparatus. The ranging apparatus may be an electronic apparatus including a laser radar or laser ranging apparatus. In one embodiment, the ranging apparatus may be used to sense external environmental information, for example, including distance information, orientation information, reflection intensity information, speed information, etc. of environmental targets. A three-dimensional data point may include at least one of the external environment information measured by the ranging apparatus.

In one implementation, the ranging apparatus can detect the distance from the object to be detected (also referred to as “to-be-detected object” or “target object”) to the ranging apparatus by measuring the time of light propagation between the ranging apparatus and the probe, that is, the time-of-flight (TOF). Alternatively, the ranging apparatus can also detect the distance from the object to be detected to the ranging apparatus through other technologies, such as a distance measuring method based on phase shift measurement or a distance measuring method based on frequency shift measurement. The present disclosure has no limit on this.

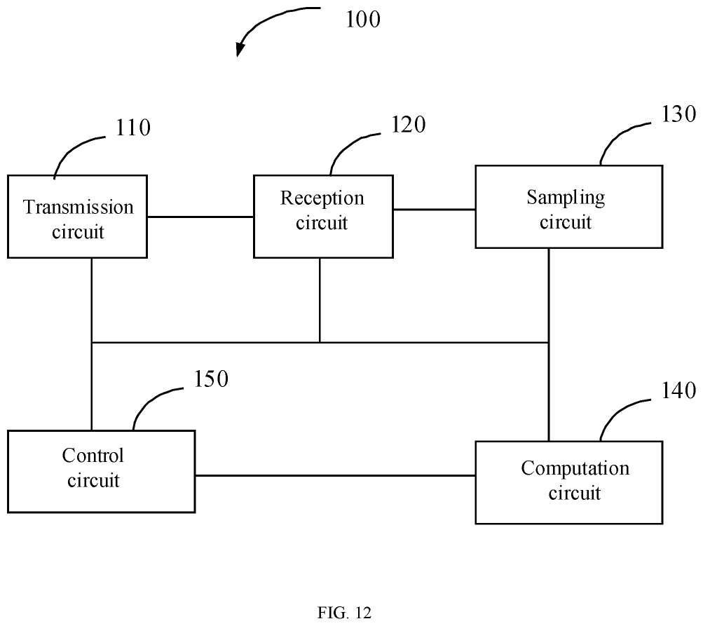

FIG. 12 shows a ranging apparatus 100 for obtaining the three-dimensional data points provided by various embodiments of the present disclosure.

As shown in FIG. 12, the ranging apparatus 100 includes a transmittion circuit 110, a reception circuit 120, a sampling circuit 130, and a computation circuit 140.

The transmittion circuit 110 may emit a light pulse sequence (for example, a laser pulse sequence). The reception circuit 120 may receive the light pulse sequence reflected by the object to be detected, and perform photoelectric conversion on the light pulse sequence to obtain an electrical signal. After processing the electrical signal, the electrical signal may be output to the sampling circuit 130. The sampling circuit 130 may sample the electrical signal to obtain the sampling result. The computation circuit 140 may determine the distance between the ranging apparatus 100 and the object to be detected based on the sampling result of the sampling circuit 130.

Optionally, the ranging apparatus 100 may further include a control circuit 150 that can control other circuits, for example, can control the working time of each circuit and/or set parameters for each circuit.

For description purpose only, the embodiment in FIG. 12 where the ranging apparatus includes a transmittion circuit, a reception circuit, a sampling circuit, and a computation circuit is used as an example to illustrate the present disclosure, and does not limit the scope of the present disclosure. In some other embodiments, the ranging apparatus may include at least two transmittion circuits, at least two reception circuits, at least two sampling circuits, or at least two computation circuits. It may be used to emit at least two light beams in the same direction or in different directions respectively. The at least two light beams can be emitted at the same time, or can be emitted at different times respectively. In an example, the light-emitting chips in the at least two transmittion circuits may be packaged in the same module. For example, each emitting circuit includes a laser emitting chip, and the dies in the laser emitting chips in the at least two emitting circuits are packaged together and housed in the same packaging space.

In some embodiments, in addition to the circuit shown in FIG. 12, the ranging apparatus 100 may further include a scanner 160 for changing the propagation direction of at least one laser pulse sequence emitted by the transmittion circuit.

The module including the transmittion circuit 110, the reception circuit 120, the sampling circuit 130, and the computation circuit 140, or the module including the transmittion circuit 110, the reception circuit 120, the sampling circuit 130, the computation circuit 140, and the control circuit 150, may be referred to as a ranging module. The ranging module may be independent of other modules, for example, the scanner 160.

A coaxial light path may be used in the ranging apparatus, that is, the light beam emitted by the ranging apparatus and the reflected light beam may share at least part of the light path in the ranging apparatus. For example, after at least one laser pulse sequence emitted by the transmitter circuit changes its propagation direction and exits through the scanner, the laser pulse sequence reflected by the probe may pass through the scanner and then enters the reception circuit. Alternatively, the ranging apparatus may also adopt an off-axis light path, that is, the light beam emitted by the ranging apparatus and the reflected light beam may be respectively transmitted along different light paths in the ranging apparatus. FIG. 12 shows a schematic diagram of an embodiment in which the ranging apparatus of the present invention adopts a coaxial light path.

The ranging apparatus 200 includes a ranging device 210, and the ranging device 210 includes a transmitter 203 (which may include the above-mentioned transmittion circuit), a collimating element 204, a detector 205 (which may include the above-mentioned reception circuit, sampling circuit, and computation circuit), and a light path changing element 206. The ranging device 210 is used to emit a light beam, receive the return light, and convert the return light into an electrical signal. Among them, the transmitter 203 can be used to emit a light pulse sequence. In one embodiment, the transmitter 203 may emit a sequence of laser pulses. Optionally, the laser beam emitted by the transmitter 203 may be a narrow-bandwidth beam with a wavelength outside the visible light range. The collimating element 204 may be arranged on the exit light path of the transmitter, and used to collimate the light beam emitted from the transmitter 203 into parallel light to be output to the scanner. The collimating element may be also used to condense at least a part of the return light reflected by the object to be detected. The collimating element 204 may be a collimating lens or other elements capable of collimating light beams.

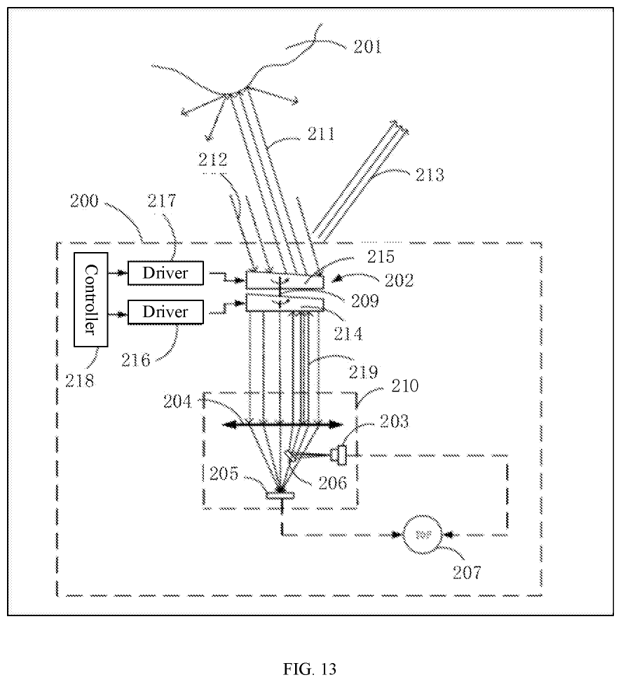

In the embodiment shown in FIG. 13, the light path changing element 206 may be used to combine the transmitting light path and the receiving light path in the ranging apparatus before the collimating element 104, such that the transmitting light path and the receiving light path can share the same collimating element. The light path may be more compact. In some other embodiments, the transmitter 103 and the detector 105 may respectively use their respective collimating elements, and the light path changing element 206 may be arranged on the light path behind the collimating elements.

In the embodiment shown in FIG. 12, since the beam aperture of the light beam emitted by the transmitter 103 is small, and the beam aperture of the return light received by the ranging apparatus is relatively large, the light path changing element can use a small-area mirror to combine the transmitting light path and the receiving light path. In some other embodiments, the light path changing element may also adopt a reflector with a through hole, where the through hole is used to transmit the emitted light of the transmitter 203 and the reflector is used to reflect the return light to the detector 205. In this way, the shielding of the back light from the support of the small reflector in the case of using the small reflector can be reduced.

In the embodiment shown in FIG. 13, the light path changing element is deviated from the optical axis of the collimating element 204. In some other embodiments, the light path changing element may also be located on the optical axis of the collimating element 204.

The ranging apparatus 200 further includes a scanner 202. The scanner 202 may be placed on the exit light path of the ranging device 210, and used to change the transmission direction of the collimated beam 219 emitted by the collimating element 204 and project it to the external environment, and project the return light to the collimating element 204. The returned light may be collected on the detector 205 via the collimating element 204.

In an embodiment, the scanner 202 may include at least one optical element for changing the propagation path of the light beam, and the optical element may change the propagation path of the light beam by reflecting, refracting, or diffracting the light beam. For example, the scanner 202 may include a lens, a mirror, a prism, a galvanometer, a grating, a liquid crystal, an optical phased array (Optical Phased Array), or any combination thereof. In an example, at least part of the optical element may be moving. For example, the at least part of the optical element may be driven to move by a driver, and the moving optical element can reflect, refract or diffract the light beam to different directions at different times. In some embodiments, the multiple optical elements of the scanner 202 can rotate or vibrate around a common axis 209, and each rotating or vibrating optical element may be used to continuously change the propagation direction of the incident light beam. In one embodiment, the multiple optical elements of the scanner 202 may rotate at different speeds or vibrate at different speeds. In some other embodiment, at least part of the optical elements of the scanner 202 may rotate at substantially the same rotation speed. In some other embodiments, the multiple optical elements of the scanner may also rotate around different axes. In some embodiments, the multiple optical elements of the scanner may also rotate in the same direction or in different directions; or vibrate in the same direction, or vibrate in different directions, which is not limited herein.

In one embodiment, the scanner 202 may include a first optical element 214 and a driver 216 connected to the first optical element 214. The driver 216 may be used to drive the first optical element 214 to rotate around the rotation axis 209, such that the first optical element 214 changes the direction of the collimated beam 219. The first optical element 214 may project the collimated beam 219 to different directions. In one embodiment, the angle between the direction of the collimated beam 219 changed by the first optical element and the rotation axis 109 may change with the rotation of the first optical element 214. In one embodiment, the first optical element 214 may include a pair of opposing non-parallel surfaces through which the collimated light beam 219 can pass. In another embodiment, the first optical element 214 may include a prism whose thickness varies in at least one radial direction. In another embodiment, the first optical element 114 may include a wedge angle prism to refract the collimated light beam 119.

In an embodiment, the scanner 202 may further include a second optical element 215. The second optical element 215 may rotate around the rotation axis 209, and the rotation speed of the second optical element 215 may be different from the rotation speed of the first optical element 214. The second optical element 215 may be used to change the direction of the light beam projected by the first optical element 214. In one embodiment, the second optical element 115 may be connected to a driver 217, and the driver 117 may drive the second optical element 215 to rotate. The first optical element 214 and the second optical element 215 can be driven by the same or different drivers, and the rotation speed and/or rotation direction of the first optical element 214 and the second optical element 215 may be different. Correspondingly, the collimated light beam 219 may be projected to the outside space in different directions and a larger space can be scanned. In one embodiment, the controller 218 may control the drivers 216 and 217 to drive the first optical element 214 and the second optical element 215, respectively. The rotational speeds of the first optical element 214 and the second optical element 215 may be determined according to the area and pattern to be scanned in actual applications. The drivers 216 and 217 may include motors or other drivers.

In one embodiment, the second optical element 115 may include a pair of opposed non-parallel surfaces through which the light beam can pass. In another embodiment, the second optical element 115 may include a prism whose thickness varies in at least one radial direction. In another embodiment, the second optical element 115 may include a wedge prism.

In one embodiment, the scanner 102 may further include a third optical element (not shown) and a driver for driving the third optical element to move. Optionally, the third optical element may include a pair of opposite non-parallel surfaces, and the light beam can pass through the pair of surfaces. In another embodiment, the third optical element may include a prism whose thickness varies in at least one radial direction. In another embodiment, the third optical element includes a wedge prism. At least two of the first, second, and third optical elements may rotate at different rotation speeds and/or rotation directions.

The rotation of each optical element in the scanner 202 can project light to different directions, such as directions 211 and 213, such that the space around the ranging apparatus 200 is scanned. FIG. 14 is a schematic diagram of a scanning pattern of the ranging apparatus 200. It is understandable that when the speed of the optical elements in the scanner changes, the scanning pattern will also change.

When the light 211 projected by the scanner 202 hits the to-be-detected object 201, a part of the light may be reflected by the to-be-detected object 201 to the ranging apparatus 200 in a direction opposite to the projected light 211. The return light 212 reflected by the to-be-detected object 201 may be incident on the collimating element 204 after passing through the scanner 202.

The detector 205 and the transmitter 203 may be placed on the same side of the collimating element 204, and the detector 205 may be used to convert at least part of the return light passing through the collimating element 204 into electrical signals.

In one embodiment, an anti-reflection coating may be plated on each optical element. Optionally, the thickness of the antireflection coating may be equal to or close to the wavelength of the light beam emitted by the transmitter 103, to increase the intensity of the transmitted light beam.

In one embodiment, a filter layer may be plated on the surface of an element located on the beam propagation path in the ranging apparatus, or a filter may be provided on the beam propagation path, for transmitting at least the wavelength band of the beam emitted by the transmitter and reflecting other bands to reduce the noise caused by ambient light to the receiver.

In some embodiments, the transmitter 203 may include a laser diode through which nanosecond laser pulses are emitted. Further, the laser pulse receiving time can be determined, for example, the laser pulse receiving time can be determined by detecting the rising edge time and/or the falling edge time of the electrical signal pulse. In this way, the ranging apparatus 200 can calculate the TOF using the pulse receiving time information and the pulse sending time information, to determine the distance between the to-be-detected object 201 and the ranging apparatus 200.

The distance and orientation detected by the ranging apparatus 200 can be used for remote sensing, obstacle avoidance, surveying and mapping, modeling, navigation, and the like. In one embodiment, the ranging apparatus of the embodiment of the present invention can be applied to a mobile platform, and the ranging apparatus can be installed on the platform body of the mobile platform. A mobile platform with a ranging apparatus can measure the external environment, for example, measuring the distance between the mobile platform and obstacles for obstacle avoidance and other purposes, and for two-dimensional or three-dimensional surveying and mapping of the external environment. In some embodiments, the mobile platform may include at least one of an unmanned aerial vehicle, a car, a remote control car, a robot, or a camera. When the ranging apparatus is applied to an unmanned aerial vehicle, the platform body may be the fuselage of the unmanned aerial vehicle. When the ranging apparatus is applied to a car, the platform body may be the body of the car. The car can be a self-driving car or a semi-autonomous car, and there is no restriction here. When the ranging apparatus is applied to a remote control car, the platform body may be the body of the remote control car. When the ranging apparatus is applied to a robot, the platform body may be the robot. When the ranging apparatus is applied to a camera, the platform body may be the camera itself.

The above embodiments are only used to illustrate the technical solutions of the present disclosure, not to limit them. Other embodiments of the disclosure will be apparent to those skilled in the art from consideration of the specification and practice of the embodiments disclosed herein. It is intended that the specification and examples be considered as examples only and not to limit the scope of the disclosure, with a true scope and spirit of the invention being indicated by the following claims.

What is claimed is:

1. A three-dimensional data point encoding method comprising:
determining maximum values of range values of an initial block of target three-dimensional data points in a radial distance direction, a zenith angle direction, and an azimuth angle direction according to position coordinates of the target three-dimensional data points in a spherical coordinate system;
performing partitioning processes on the initial block, including:
performing at least one octree partitioning process on the initial block to obtain a plurality of first-type sub-blocks; and
performing at least one of a quadtree partitioning process or a binary tree partitioning process on at least one of the plurality of first-type sub-blocks; and
encoding the target three-dimensional data points according to partitioning results of the initial block.

2. The method according to claim 1, wherein encoding the target three-dimensional data points includes:
sequentially encoding situations of the partitioning processes according to a partitioning order and point-containing situations of sub-blocks obtained by the partitioning processes.

3. The method according to claim 2, wherein sequentially encoding the situations of the partitioning processes includes:
for each one partitioning process of the partitioning processes, obtaining a code stream corresponding of the one partitioning process according to the point-containing situations of the sub-blocks obtained by the one partitioning process; and
sequentially encoding the code streams corresponding to the partitioning processes according to the partitioning order.

4. The method according to claim 3, wherein for each one partitioning process of the partitioning processes, obtaining the code stream corresponding to the one partitioning process includes:
according to the point-containing situations of the sub-blocks obtained by the one partitioning process, obtaining a bitstream corresponding to the sub-blocks, each of the sub-blocks corresponding to one bit, and a bit value corresponding to one of the sub-blocks containing one or more of the target three-dimensional data points is different from a bit value corresponding to another one of the sub-blocks not containing any of the target three-dimensional data points; and
generating the code stream corresponding to the one partitioning process according to the bit values corresponding to the sub-blocks.

5. The method according to claim 4, wherein:
the code stream corresponding to each of the partitioning processes includes 8 bits; and
generating the code stream corresponding to the one partitioning process includes:
in response to the one partitioning process being octree partitioning, determining bit values of the 8 bits according to point-containing situations of eight sub-blocks obtained by the one partitioning process;
in response to the one partitioning process being quadtree partitioning, determining bit values of 4 bits of the 8 bits according to point-containing situations of four sub-blocks obtained by the one partitioning process, and determining bit values of remaining 4 bits of the 8 bits to be same as a bit value of a sub-block that does not contain any of the target three-dimensional data points; or
in response to the one partitioning process being binary tree partitioning, determining bit values of 2 bits of the 8 bits according to point-containing situations of two sub-blocks obtained by the one partitioning process, and determining bit values of remaining 6 bits of the 8 bits to be same as a bit value of a sub-block that does not contain any of the target three-dimensional data points.

6. The method according to claim 4, wherein generating the code stream corresponding to the one partitioning process includes:
in response to the one partitioning process being octree partitioning and the code stream corresponding to the one partitioning process including 8 bits, determining bit values of the 8 bits according to point-containing situations of eight sub-blocks obtained by the one partitioning process;
in response to the one partitioning process being quadtree partitioning and the code stream corresponding to the one partitioning process including 4 bits, determining bit values of the 4 bits according to point-containing situations of four sub-blocks obtained by the one partitioning process;
in response to the one partitioning process being binary tree partitioning and the code stream corresponding to the one partitioning process including 2 bits, determining bit values of the 2 bits according to point-containing situations of two sub-blocks obtained by the one partitioning process.

7. A three-dimensional data point decoding method, comprising:
obtaining a code stream;
determining, according to the code stream, maximum values of range values of an initial block in three directions including a radial distance direction, a zenith angle direction, and an azimuth angle direction;
constructing the initial block according to the maximum values of the range values;
performing partitioning processes on the initial block, including:
performing at least one octree partitioning process on the initial block to obtain a plurality of first-type sub-blocks; and
performing at least one of a quadtree partitioning process or a binary tree partitioning process on at least one of the plurality of first-type sub-blocks; and
obtaining position coordinates of target three-dimensional data points according to positions of sub-blocks obtained by the partitioning processes.

8. The method according to claim 7, further comprising:
decoding a identifierused to indicate a change of a partitioning mode, the partitioning mode including octree partitioning, quadtree partitioning, or binary tree partitioning; and
changing the partitioning mode according to the identifier.

9. The method according to claim 7, further comprising:
decoding a identifier used to indicate a direction in which the range value has reached a minimum accuracy or a direction in which the range value has not reached the minimum accuracy; and
determining, according to the identifier, the direction in which the range value has reached the minimum accuracy or the direction in which the range value has not reached the minimum accuracy.

10. The method according to claim 7, further comprising:
decoding a identifierused to indicate an end of partitioning; and
determining that the partitioning has ended according to the identifier.

11. The method to claim 7, wherein:
the maximum values of the range values of the initial block in the three directions are same; and
performing the at least one of the quadtree partitioning process or the binary tree partitioning process on the at least one of the plurality of first-type sub-blocks includes:
determining whether to perform the quadtree partitioning process or the binary tree partitioning process according to a first identifier and a second identifier; and
determining an end of partitioning according to a third identifier.

12. The method according to claim 7, wherein determining the maximum values of the range values of the initial block includes:
obtaining, according to the code streams, minimum values after quantization and maximum values after quantization of the position coordinates in the three directions;
obtaining maximum values of range values of the position coordinates in the radial distance direction, in the zenith angle direction, and in the azimuth angle direction according to the minimum values after quantization and the maximum values after quantization of the position coordinates; and
obtaining the maximum values of the range values of the initial block in the radial distance direction, in the zenith angle direction, and in the azimuth angle direction according to the maximum values of the range values of the position coordinates in the radial distance direction, in the zenith angle direction, and in the azimuth angle direction.

13. The method according to claim 12, wherein obtaining the maximum values of the range values of the initial block in the radial distance direction, in the zenith angle direction, and in the azimuth angle direction according to the maximum values of the range values of the position coordinates in the radial distance direction, in the zenith angle direction, and in the azimuth angle direction includes:
in each direction, determining a value among values that are an integer power of 2 and are greater than or equal to the maximum value of the range value of the position coordinates that is closest to the maximum value of the range value as the maximum value of the range value of initial block in the corresponding direction.

14. The method according to claim 12, wherein obtaining the minimum values after quantization and the maximum values after quantization of the position coordinates in the three directions includes:
obtaining minimum values before quantization and maximum values before quantization of the position coordinates in the three directions according to the code stream; and
obtaining the minimum values after quantization and the maximum values after quantization of the position coordinates in the three directions according to the minimum values before quantization and the maximum values before quantization of the position coordinates and quantization step lengths in the three directions.

15. The method according to claim 12, wherein obtaining the minimum values after quantization and the maximum values after quantization of the position coordinates in the three directions includes:
obtaining, according to the code stream, minimum values before quantization and the maximum values after quantization of the position coordinates in the three directions; and
obtaining the minimum values after quantization according to the minimum values before quantization of the position coordinates and quantization step lengths in the three directions.

16. The method according to claim 12, wherein obtaining the minimum values after quantization and the maximum values after quantization of the position coordinates in the three directions includes:
obtaining, according to the code stream, the minimum values after quantization and maximum values before quantization of the position coordinates in the three directions; and
obtaining the maximum values after quantization of the position coordinates in the three directions according to the maximum values before quantization of the position coordinates and quantization step lengths in the three directions.

17. The method according to claim 12, wherein obtaining the minimum values after quantization and the maximum values after quantization of the position coordinates in the three directions according to the code streams includes:
obtaining, according to the code streams, minimum values before quantization and a maximum value of the maximum values after quantization of the position coordinates in the three directions;
obtaining the minimum values after quantization according to the minimum values before quantization of the position coordinates and quantization step lengths in the three directions; and
determining the maximum value of the maximum values after quantization as the maximum value after quantization in each of the three directions.

18. The method according to claim 12, wherein obtaining the minimum values after quantization and the maximum values after quantization of the position coordinates in the three directions includes:
obtaining, according to the code streams, the minimum values before quantization and a minimum value of the maximum values after quantization of the position coordinates in the three directions;
obtaining the minimum values after quantization according to the minimum values before quantization of the position coordinates and quantization step lengths in the three directions; and
determining the minimum value of the maximum values after quantization as the maximum value after quantization in each of the three directions.

19. The method according to claim 12, wherein obtaining the minimum values after quantization and the maximum values after quantization of the position coordinates in the three directions includes:
obtaining, according to the code streams, the minimum values after quantization and a maximum value of the maximum values after quantization of the position coordinates in the three directions; and
determining the maximum value of the maximum values after quantization as the maximum value after quantization in each of the three directions.

20. The method according to claim 12, wherein obtaining the minimum values after quantization and the maximum values after quantization of the position coordinates in the three directions includes:
obtaining, according to the code streams, the minimum values after quantization and a minimum value of the maximum values after quantization of the position coordinates in the three directions; and
determining the minimum value of the maximum values after quantization as the maximum value after quantization in each of the three directions.
